(19) United States
(12) Patent Application Publication
(10) Pub. No.: US 2024/0319892 A1
(43) Pub. Date: Sep. 26, 2024

(54) SYSTEMS, APPARATUSES, AND METHODS FOR DECENTRALIZED GENERATION, STORAGE, AND/OR MANAGEMENT OF ENCRYPTED DATA

(71) Applicant: Dedi Corp., Calgary (CA)

(72) Inventors: Kevin Wong, Calgary (CA); Trevor Paquette, Calgary (CA)

(73) Assignee: Dedi Corp., Calgary (CA)

(21) Appl. No.: 18/618,640

(22) Filed: Mar. 27, 2024

Related U.S. Application Data
(63) Continuation of application No. PCT/CA24/50366, filed on Mar. 25, 2024.
(60) Provisional application No. 63/491,989, filed on Mar. 24, 2023.

(51) Int. Cl. G06F 3/06

(52) U.S. Cl. CPC G06F 3/0622; G06F 3/0655; G06F 3/0676; G06F 3/0679

(57) ABSTRACT

A method has the steps of: selectively storing one or more data pieces in at least one first device based on a group of one or more characteristics of the one or more data pieces and/or one or more characteristics of the at least one first device, the at least one first device being a physical or virtual device; the one or more characteristics of the one or more data pieces and the one or more characteristics of the at least one first device are unrelated to a storage capacity of the at least one first device.

### CROSS-REFERENCE TO RELATED APPLICATIONS

This application claims the benefit of U.S. Provisional Patent Application Ser. No. 63/491,989, filed Mar. 24, 2023, the content of which is incorporated herein by reference in its entirety.

### FIELD OF THE DISCLOSURE

The present disclosure relates generally to systems, apparatuses, and methods for generation, storage, retrieval, and/or management of encrypted data, and in particular to systems, apparatuses, and/or methods for generation, storage, retrieval, and management of encrypted data in a decentralized manner.

### BACKGROUND

With the rapid growth of Internet and online activities, privacy breaches due to mass hacks cause more and more damages and negative impacts globally. Other rapidly expanding areas such as Internet of Things (IoT) devices, blockchain and cryptocurrency are also exposed to similar risks.

Many cybersecurity methods have been used for reducing mass hacking, which generally involve strong data-access controls and strong encryption. For example, some methods seek to mitigate mass hacks by increasing security measures with heightened protocols such as two-factor authentication and enhanced password requirements. However, such increased security measures cannot eliminate the risk of mass hacks.

Encryption technologies are also widely used for preventing mass hacks wherein data is encrypted using an encryption key and can only be decrypted by using a corresponding decryption key. Depending on the encryption technologies used, the encryption and decryption keys (collectively denoted “cryptographic keys”) may be the same key (symmetric encryption) or may be different keys (asymmetric encryption).

For example, hardware security modules (HSMs) and/or keyservers, may be used for encryption, decryption, and authentication. As those skilled in the art understand, a HSM is a physical module (for example, in the form of a hardware card plugged to a suitable slot of a computer motherboard, an external device connected to a computer, or a network connected device) for managing and protecting secrets such as digital keys, and performing cryptographic functions such as encryption, decryption, authentication, and/or the like.

Today, some of the most common types of HSMs include:
Dedicated HSMs, which are hardware keyservers exclusively used by (and often controlled by) the users of a specific entity such as a company or a government. Such dedicated keyservers are usually highly secure. However, the cost of dedicated keyservers may be prohibitively high. Moreover, keyservers may lack scalability.
Do-it-yourself software HSMs, which are low-cost keyservers setup by users (such as software developers). Such keyservers may have reduced security due to cost considerations and/or lack of professional skills in cybersecurity.
Shared-hardware HSM-as-a-service, which is a cloud-based cryptographic-key storage service built on one or more hardware keyservers to allow a large number of users to share the underlying hardware and store their cryptographic keys therein. Although the cost of the hardware keyservers is high, the per-user or per-key cost may be significantly lowered when a large number of users use HSM service to store their cryptographic keys (for example, thousands of users storing billions of cryptographic keys). However, such keyserver service may be insecure because:
   The cryptographic keys are often stored near the same server that holds the corresponding encrypted data. Thus, a hacker successfully hacking the cryptographic keys may easily locate and hack the data.
   The keyserver service often stores a large number of cryptographic keys in a small number of keyservers. Therefore, a successfully hacking a keyserver may cause the leakage of a large number of cryptographic keys.

### SUMMARY

According to one aspect of this disclosure, there is provided a method comprising: selectively storing one or more data pieces in at least one first device based on a group of one or more characteristics of the one or more data pieces and/or one or more characteristics of the at least one first device, the at least one first device being a physical or virtual device; the one or more characteristics of the one or more data pieces and the one or more characteristics of the at least one first device are unrelated to a storage capacity of the at least one first device.

In some embodiments, said selectively storing the one or more data pieces in the at least one first device comprises: selecting one of the at least one first device; determining that the group of the one or more characteristics of the one or more data pieces and/or the one or more characteristics of the at least one first device satisfy a group of one or more conditions; and storing the one or more data pieces in the selected one of the at least one first device.

In some embodiments, the group of one or more conditions comprise: a total number of the one or more data pieces being smaller than or equal to a predefined maximum data-piece number; the one or more data pieces belonging to a same owner or a predefined maximum number of multiple owners; the one or more data pieces being related to a same application program or a predefined maximum number of multiple application programs; the one or more data pieces being encrypted using a same encryption key or a predefined maximum number of multiple encryption keys; the one or more data pieces being encrypted using mutually different encryption keys; the one or more data pieces being a same type; the one or more data pieces being encrypted, and encrypted the one or more data pieces and one or more cryptographic keys stored in the in at least one first device being unrelated to the encrypted one or more data pieces; or a combination thereof.

In some embodiments, the method further comprises: managing one or more users and the at least one first device using a first hierarchical structure of the one or more users, a second hierarchical structure of the at least one first device, and a mapping between the first and second hierarchical structures.

In some embodiments, the first hierarchical structure comprises: a top-level node of service host, one or more nodes of partners associated with the node of service host, one or more nodes of providers associated with each of the one or more nodes of partners, and one or more nodes of subscribers associated with each of the one or more nodes of providers; and the one or more users comprise the service host, the one or more partners, the one or more providers, and the one or more node of subscribers.

In some embodiments, said managing the one or more users and the at least one first device comprises: managing a first user of the one or more users, the first user being classified as one of the one or more partners, one of the one or more partners, or one of the one or more subscribers; and said managing the first user comprises: receiving a join request from a computing device, generating a registration token, sending the registration token to the computing device, receiving an identifier (ID) of the first user and a join token from the computing device, verifying the join token, registering the ID of the first user, generating an ID-update token, and sending the ID-update token to the computing device.

In some embodiments, said managing the one or more users and the at least one first device further comprises: updating information of the first user using the ID-update token.

In some embodiments, the second hierarchical structure comprises: a top-level node of realm; one or more nodes of perimeters associated with the node of realm; one or more nodes of bunkers associated with each of the one or more nodes of perimeters; and a node of the at least one first device associated with one of the one or more nodes of bunkers.

In some embodiments, the node of realm is mapped the node of service host, the one or more nodes of perimeters are mapped to the one or more nodes of partners, the one or more nodes of bunkers are mapped to the one or more nodes of providers, and the node of the at least one first device is mapped to one of the one or more nodes of subscribers.

In some embodiments, the method further comprises: creating a first safe in the at least one first device; creating a first nugget in the first safe; and storing one of the one or more data pieces in the first nugget; the first safe and the first nugget are data structures.

In some embodiments, the first nugget comprises metadata.

In some embodiments, said creating the first safe in the at least one first device comprises: creating a vault in the at least one first device; and the first safe in the vault; the vault is a data structure.

In some embodiments, each of the at least one first device only comprises one vault.

In some embodiments, the first nugget is of a first type; and the first type of for data storage and is accessible without through another nugget.

In some embodiments, the first nugget is of a second type; and the second type is for data storage and is accessible through a nugget of a third type.

In some embodiments, the third type is for storing a link pointing to a second-type nugget.

In some embodiments, the method further comprises: storing a second-type nugget or storing a third-type nugget; said storing the second-type nugget comprises: identifying a second safe that does not have any third-type nugget, and storing the second-type nugget in the second safe; and said storing the second-type nugget comprises: identifying a third safe that does not have any second-type nugget, and storing the third-type nugget in the third safe.

In some embodiments, the method further comprises: manipulating a second-type nugget or a third-type nugget in accordance with the following rules: storing the second-type nugget and the third-type nugget in different safes; disallowing storage of a link pointing to a first-type nugget in the third-type nugget; disallowing storage of a link pointing to a second-type nugget in the third-type nugget if the second-type nugget and the third-type nugget are in a same safe; disallowing updating of a link stored in the third-type nugget; allowing updating of data stored in the second-type nugget via a link stored in the third-type nugget that points to the second-type nugget; or a combination thereof.

In some embodiments, the method further comprises: finding the first nugget by searching the at least one first device using an ID of the first nugget; or finding the first nugget by (i) searching the at least one first device using an ID of a query initiator to obtain a nugget list, and (ii) searching the nugget list using the ID of the first nugget.

In some embodiments, the method further comprises: calling a domain name system (DNS) query function with a name of a root cluster to obtain a list of addresses of one or more first discovery servers; the root cluster comprises a plurality of discovery servers including the one or more first discovery servers; and the DNS query function receives an input parameter and comprises: determining a node type of the input parameter, if the node type of the input parameter is a first node type, obtaining one or more DNS pointer (PTR) records for the input parameter, and for each PTR record of the one or more PTR records, calling the DNS query function with a name of a node in the PTR record as the input parameter, if the node type of the input parameter is a second node type, obtaining one or more DNS service (SRV) records for the input parameter, and including addresses in the one or more SRV records into the list of addresses of the one or more first discovery servers.

In some embodiments, said managing the at least one first device comprises: receiving a creation request from the at least one first device; generating a device-ID-creation token; sending the device-ID-creation token to the at least one first device; receiving a device ID of the at least one first device and a device-ID-registration token from the at least one first device; verifying the device-ID-registration token; registering the device ID; generating a device-ID-update token; and sending the device-ID-update token to the at least one first device.

In some embodiments, the method further comprises: converting a nugget ID in a received query to a hash of the nugget ID; searching the hash of the nugget ID to obtain a hash of a vault ID; searching the hash of the vault ID to obtain a list of one or more hashes of device IDs; and searching each hash of the one or more hashes of device IDs to obtain an IP address and port of a device corresponding to the hash.

According to one aspect of this disclosure, there is provided a computer system for performing the above-described method, the computer system comprising: the at least one first device comprising: one or more storage media; and one or more processors connected to the one or more storage media for performing the above-described method.

According to one aspect of this disclosure, there is provided one or more non-transitory computer-readable storage media comprising computer-executable instructions, wherein the instructions, when executed, cause one or more processors to perform the above-described method.

### BRIEF DESCRIPTION OF THE DRAWINGS

For a more complete understanding of the disclosure, reference is made to the following description and accompanying drawings, in which:

FIG. 1 is a schematic diagram of a computer network system, according to some embodiments of the present disclosure;

FIG. 2 is a schematic diagram showing a simplified hardware structure of a computing device of the computer network system shown in FIG. 1;

FIG. 3 a schematic diagram showing a simplified software architecture of a computing device of the computer network system shown in FIG. 1;

FIG. 4 is a flowchart showing a data-storage process performed by a management server of the computer network system shown in FIG. 1, according to some embodiments of the present disclosure;

FIG. 5 is a schematic diagram showing a hierarchical structure for managing users of the computer network system shown in FIG. 1 and their access rights, data organization, service registration, service discovery, and/or the like, according to some embodiments of the present disclosure;

FIG. 6 is a schematic diagram showing a hierarchical structure for managing the storage servers of the computer network system shown in FIG. 1, according to some embodiments of the present disclosure;

FIG. 7 is a schematic diagram showing a mapping between the user-management hierarchical structure shown in FIG. 5 and the device-management hierarchical structure shown in FIG. 6;

FIGS. 8A to 8C are schematic diagrams showing examples of the user-management and device-management hierarchical structures shown in FIGS. 5 and 6, respectively, for managing the users and storage servers;

FIG. 9 is a schematic diagram showing a hierarchical structure for managing data stored in each storage server of the computer network system shown in FIG. 1, according to some embodiments of the present disclosure;

FIGS. 10A and 10B are schematic diagrams showing an example of sharing secrets between two subscribers using normal nuggets shown in FIG. 9, according to some embodiments of the present disclosure;

FIG. 11 is a schematic diagram showing an example of sharing secrets between two subscribers using linked and linking nuggets shown in FIG. 9, according to some embodiments of the present disclosure;

FIG. 12 is a flowchart showing a partner-registration process for a new partner to join a realm, according to some embodiments of the present disclosure;

FIG. 13 is a flowchart showing a provider-registration process for a new provider to register under a partner, according to some embodiments of the present disclosure;

FIG. 14 is a flowchart showing a subscriber-registration process for a new subscriber to register under a provider, according to some embodiments of the present disclosure;

FIG. 15 is a schematic diagram showing the registration states of an element of the computer network system shown in FIG. 1, according to some embodiments of the present disclosure;

FIG. 16A is a schematic diagram showing a discovery-list-building process performed by the computer network system shown in FIG. 1, according to some embodiments of this disclosure;

FIG. 16B is a schematic diagram showing the detail of a DNS query step and a building discovery list step of the discovery-list-building process shown in FIG. 16A;

FIG. 17 is a flowchart showing a device registration process performed by the computer network system shown in FIG. 1, according to some embodiments of this disclosure;

FIG. 18 is a schematic diagram showing the computer network system shown in FIG. 1 performing a discovery process; and

FIG. 19 is a schematic diagram showing a conventional computer network system.

### DETAILED DESCRIPTION

Embodiments disclosed herein relate to systems, apparatuses, and/or methods for generation, storage, and management of encrypted and/or unencrypted data in a decentralized manner. The systems, apparatuses, and/or methods disclosed herein have several unique features combining necessary hardware and software components to provide users or clients data-storage solutions with enhanced security and with a fraction of the cost and requisite infrastructure, compared to conventional solutions.

More specifically, the systems, apparatuses, and/or methods disclosed herein:
may comprise and use a plurality of storage-servers of low-cost (for example, as low as US$10 each), small sizes (for example, as small as a pack of sticky notes), and low power consumption (for example, less than two (2) Amps (A) under load);
may comprise and use a plurality of software-implemented “virtual” storage-servers;
may store data or “secrets”
may support data and/or cryptographic-key retrievals with less than 300 milliseconds (ms) access times; and
may be easy to customize and require minimal training.

Compared to traditional data and key storage providers using shared hardware (such as shared servers) to store all data and/or keys of all clients in one place, the systems, apparatuses, and/or methods disclosed herein use a decentralized approach such that each storage server does not need to handle a heavy load of data/key retrieval (for example, millions of retrievals a minute). By distributing the workload over hundreds, thousands, or millions of storage servers or devices, each device only needs to handle a tiny fraction of the otherwise high traffic.

The systems, apparatuses, and/or methods disclosed herein support a variety of key types and formats, SSL certificates, passwords, digital files (such as images, emails, pdf files, Office files, non-fungible tokens (NFTs), blockchain private keys), and/or the like.

As will be described in more detail below, the systems, apparatuses, and/or methods disclosed herein de-centralize data storage and spread it across a large number of storage servers while maintaining the same use experience for a developer or and end-user, regardless how many storage servers are used. The systems, apparatuses, and/or methods disclosed herein achieve such an experience by providing a combination of:
individual storage servers;
a plurality of programmatic interfaces for each service and/or each storage-server;
a plurality of services such as partner and provider services, registration and discovery systems, billing, and/or the like;
software development kits (SDKs) for software developers to interface their applications into the computer network systems disclosed herein; in various embodiments, the SDKs may include PHP, Java, Go, Rust, C, C++, and/or the like.

The systems, apparatuses, and/or methods disclosed herein provide many important benefits such as:
operators of the systems disclosed herein have no access to users' data (such as their cryptographic keys) stored in the storage servers of the system;
great affordability;
great scalability; and
ease of use.

### A. System Structure

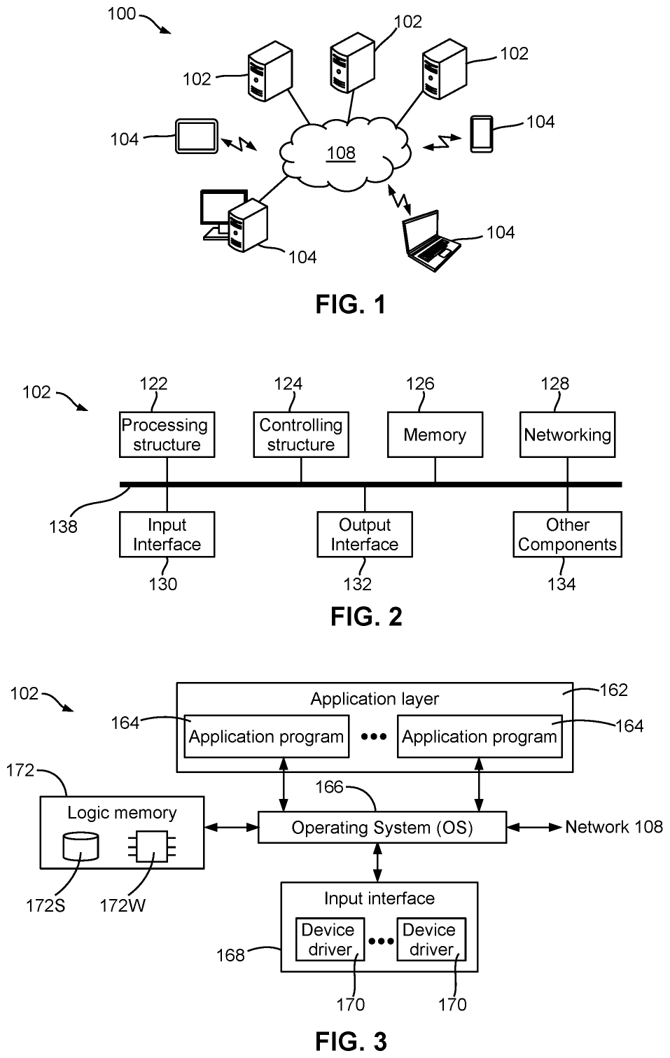

Turning now to FIG. 1, a computer network system for decentralized generation, storage, and/or management of encrypted and/or unencrypted data is shown and is generally identified using reference numeral 100. As shown, the computer network system 100 comprises a plurality of server computers 102 and a plurality of client computing-devices 104 functionally interconnected by a network 108, such as the Internet, a local area network (LAN), a wide area network (WAN), a metropolitan area network (MAN), and/or the like, via suitable wired and/or wireless networking connections. The client computing-devices 104 may be portable and/or non-portable computing devices such as laptop computers, tablets, smartphones, personal digital assistants (PDAs), desktop computers, server computers, and/or the like. The client computing-device 104 may have a hardware structure and a software structure similar to those of the server computer 102 (described in more detail later).

Generally, the server computers 102 may be computing devices designed specifically for use as a server, or general-purpose computing devices acting as server computers while also being used by various users, system on a chip (SoC) systems, and/or the like. In these embodiments, the server computers 102 are preferably low-cost, small-size, and low-power-consumption computing devices that may be arranged in one or more racks for securely generating, storing, and/or managing encrypted and/or unencrypted data (including cryptographic keys which is considered a special type of data hereinafter).

FIG. 2 is a schematic diagram showing a simplified hardware structure of the server computer 102. As shown, the server computer 102 comprises a processing structure 122, a controlling structure 124, one or more non-transitory computer-readable memory or storage devices 126, a network interface 128, an input interface 130, and an output interface 132, functionally interconnected by a system bus 138. The server computer 102 may also comprise other components 134 coupled to the system bus 138.

The processing structure 122 may be one or more single-core or multiple-core computing processors such as ARM® microprocessors (ARM is a registered trademark of Arm Ltd., Cambridge, UK) manufactured by a variety of manufactures such as Qualcomm of San Diego, California, USA, under the ARM® architecture, or the like. When the processing structure 122 comprises a plurality of processors, the processors thereof may collaborate via a specialized circuit such as a specialized bus or via the system bus 138. In other embodiments, other processors may also be used, such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), real-time processors, programmable logic controllers (PLCs), microcontroller units (MCUs), u-controllers (UCs), specialized/customized processors and/or controllers using, for example, field-programmable gate array (FPGA) or application-specific integrated circuit (ASIC) technologies, and/or the like.

Generally, each processor of the processing structure 122 comprises necessary circuitries implemented using technologies such as electrical and/or optical hardware components for executing one or more processes as the implementation purpose and/or the use case maybe, to perform various tasks. In many embodiments, the one or more processes may be implemented as firmware and/or software stored in the memory 126. Those skilled in the art will appreciate that, in these embodiments, the one or more processors of the processing structure 122, are usually of no use without meaningful firmware and/or software.

Of course, those skilled the art will appreciate that a processor may be implemented using other technologies such as analog technologies.

The controlling structure 124 comprises one or more controlling circuits, such as graphic controllers, input/output chipsets, and the like, for coordinating operations of various hardware components and modules of the server computer 102.

The memory 126 comprises one or more one or more non-transitory computer-readable storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like. In use, the memory 126 is generally divided into a plurality of portions for different use purposes. For example, a portion of the memory 126 (denoted as storage memory herein) may be used for long-term data storing, for example, for storing files or databases. Another portion of the memory 126 may be used as the system memory for storing data during processing (denoted as working memory herein).

The network interface 128 comprises one or more network modules for connecting to other computing devices or networks through the network 108 by using suitable wired and/or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, and/or the like. In some embodiments, parallel ports, serial ports, USB connections, optical connections, or the like may also be used for connecting other computing devices or networks although they are usually considered as input/output interfaces for connecting input/output devices.

The Input Interface 130 comprises one or more Input modules for one or more users to input data via, for example, touch-sensitive screens, touch-sensitive whiteboards, touchpads, keyboards, computer nice, trackballs, microphones, scanners, cameras, and/or the like. The input interface 130 may be a physically integrated part of the server computer 102 (for example, the touchpad of a laptop computer or the touch-sensitive screen of a tablet), or may be a device physically separated from but functionally coupled to, other components of the server computer 102 (for example, a computer mouse). The input interface 130, in some implementation, may be integrated with a display output to form a touch-sensitive screen or a touch-sensitive whiteboard.

The output interface 132 comprises one or more output modules for output data to a user. Examples of the output modules include displays (such as monitors, LCD displays, LED displays, projectors, and the like), speakers, printers, virtual reality (VR) headsets, augmented reality (AR) goggles, and/or the like. The output interface 132 may be a physically integrated part of the server computer 102 (for example, the display of a laptop computer or a tablet), or may be a device physically separate from but functionally coupled to other components of the server computer 102 (for example, the monitor of a desktop computer).

The server computer 102 may also comprise other components 134 such as one or more positioning modules, temperature sensors, barometers, inertial measurement units (IMUs), and/or the like. Examples of the positioning modules may be one or more global navigation satellite system (GNSS) components (for example, one or more components for operation with the Global Positioning System (GPS) of USA, Global′naya Navigatsionnaya Sputnikovaya Sistema (GLONASS) of Russia, the Galileo positioning system of the European Union, and/or the Beidou system of China).

The system bus 138 Interconnects various components 122 to 134 enabling them to transmit and receive data and control signals to and from each other.

From the computer point of view, server computer 102 may comprise a plurality of modules. Herein, a “module” refers to a hardware structure such as a circuitry implemented using technologies such as electrical and/or optical technologies for performing defined operations or processings. A “module” may alternatively refer to the combination of a hardware structure and a software structure, wherein the hardware structure may be implemented using technologies such as electrical and/or optical technologies in a general manner for performing defined operations or processings according to the software structure in the form of a set of instructions stored in one or more non-transitory, computer-readable storage devices or media.

As a part of a device, an apparatus, a system, and/or the like, a module may be coupled to or integrated with other parts of the device, apparatus, or system such that the combination thereof forms the device, apparatus, or system. Alternatively, the module may be implemented as a standalone device or apparatus.

FIG. 3 shows a simplified software architecture of the server computer 102. The software architecture 160 comprises an application layer 162, an operating system 166, a logical input/output (I/O) interface 168, and a logical memory 172. The application layer 162, operating system 166, and logical I/O interface 168 are generally implemented as computer-executable instructions or code in the form of software programs or firmware programs stored in the logical memory 172 which may be executed by the processing structure 122.

Herein, a software or firmware program is a set of computer-executable instructions or code stored in one or more non-transitory computer-readable storage devices or media such as the memory 126, and may be read and executed by the processing structure 122 and/or other suitable components of the server computer 102 for performing one or more processes. Those skilled in the art will appreciate that a program may be implemented as either software or firmware, depending on the design purposes and requirements. Therefore, for ease of description, the terms “software” and “firmware” may be interchangeably used hereinafter.

Herein, a process has a general meaning equivalent to that of a method, and does not necessarily correspond to the concept of computing process (which is the instance of a computer program being executed). More specifically, a process herein is a defined method implemented as software or firmware programs executable by hardware components for processing data (such as data received from users, other computing devices, other components of the server computer 102, and/or the like). A process may comprise or use one or more functions for processing data as designed. Herein, a function is a defined sub-process or sub-method for computing, calculating, or otherwise processing input data in a defined manner and generating or otherwise producing output data.

Alternatively, a process may be implemented as one or more hardware structures having necessary electrical and/or optical components, circuits, logic gates, integrated circuit (IC) chips, and/or the like.

Referring back to FIG. 3, the application layer 162 comprises one or more application programs 164 executed by or performed by the processing structure 122 for performing various tasks.

The operating system 166 manages various hardware components of the server computer 102 via the logical I/O interface 168, manages the logical memory 172, and manages and supports the application programs 164. The operating system 166 is also in communication with other computing devices (not shown) via the network 108 to allow the application programs 164 to communicate with programs running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® IOS (APPLE is a registered trademark of Apple Inc., Cupertino, CA, USA), Linux, ANDROID® (ANDROID is a registered trademark of Google Inc., Mountain View, CA, USA), or the like. The server computers 102 of the computer network system 100 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the application layer 162 for being processed by one or more application programs 164. Data generated by the application programs 164 may be sent to the logical I/O interface 168 for outputting to various output devices (via the output interface 132).

The logical memory 172 Is a logical mapping of the physical memory 126 for facilitating the application programs 164 to access. In this embodiment, the logical memory 172 comprises a storage memory area 172S that may be mapped to a non-volatile physical memory such as hard disks, solid-state disks, flash drives, and/or the like, generally for long-term data storage therein. The logical memory 172 also comprises a working memory area 172W that is generally mapped to high-speed, and in some implementations, volatile physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the application layer 162 generally comprises one or more server-side application programs 164 which provide(s) server functions for managing network communication with client computing-devices 104 and facilitating collaboration between the server computer 102 and the client computing-devices 104. Herein, the term “server” may refer to a server computer 102 from a hardware point of view, or to a logical server from a software point of view, depending on the context.

As described above, the processing structure 122 is usually of no use without meaningful firmware and/or software. Similarly, while a computer system 100 may have the potential to perform various tasks, it cannot perform any tasks and is of no use without meaningful firmware and/or software. As will be described in more detail later, the computer system 100 described herein, as a combination of hardware and software, generally produces tangible results tied to the physical world, wherein the tangible results such as those described herein may lead to improvements to the computer and system themselves.

B. Decentralized Generation and/or Storage of Encrypted and/or Unencrypted Data

As described above, the server computers 102 may be used for decentralized generation, storage, and/or management of encrypted and/or unencrypted (also called “plaintext”) data (simply denoted “data” hereinafter). In some embodiments, such server computers 102 (denoted “storage servers” or “devices” hereinafter) are preferably low cost, small size, and low-power-consumption computing devices that may be arranged in one or more racks more densely than conventional sever computers in the racks. In some embodiments, the storage servers 102 may comprise HSMs for enhanced cryptographic security.

Herein, a storage server or device 102 is a computing device for hosting and managing data (also called “secrets”) and responding to query requests. A device 102 may be a general-purpose or dedicated computer server, a general-purpose or dedicated micro-server or micro-controller, a docker software and/or virtual container(s) running on a host computer, a dedicated virtual server, a full-blown server, or the like.

The computer network system 100 may comprise a large number of storage servers 102 with a reasonable cost, thereby allowing limiting or otherwise regulating the data securely stored in the storage servers 102.

More specifically, the computer network system 100 may comprise one or more management server computers 102′ (simply denoted “management servers” hereinafter), which may be storage servers 102 or separate computer servers, for selectively storing data in each storage server 102 based on one or more characteristics of the data and/or the storage server 102, and managing the data stored therein. In other words, each storage server 102 is configured with restriction of the data stored therein, wherein the restriction is based on one or more characteristics of the data and/or the storage server 102, and is generally independent to or unrelated to the storage capacity of the storage server, provided that the total size of the stored data is smaller than the storage capacity of the storage server.

For example, in some embodiments, each storage server 102 may only store up to a predefined maximum number of data pieces such that a hacking to a storage server 102 may only cause limited cybersecurity breach, if any. Depending on the requirement (such as the importance of the data pieces) and/or use scenarios, the predefined maximum number may be one, two, three, no more than 10, no more than 100, or the like. These embodiments may be particularly useful for storing cryptographic keys. In these embodiments, the total size of the predefined maximum number of data pieces may be much smaller than the storage capacity of the storage server 102. In other words, once determined or defined, the predefined maximum number is independent to the sizes of the data pieces and may be considered a constant, provided that the total size of the predefined maximum number of data pieces is smaller than the storage capacity of the storage server. Contrarily, in conventional data storages, the number of data pieces stored in a storage server generally varies depending on the sizes of the data pieces and the storage capacity of the storage server.

In some other embodiments, each storage server 102 may only store data pieces of the same owner. Herein, a data owner may be any suitable entity owning the data such as a user, an organization, a company, a department of an organization, a geographic group, or the like. Thus, a hacking to a storage server 102 storing a department's cryptographic keys would not directly cause risks to the security of other departments' cryptographic keys (as they are stored in other storage servers).

In yet some other embodiments, each storage server 102 may only store data pieces of a predefined maximum number of owners.

In some other embodiments, each storage server 102 may only store data pieces related to (for example, for use by, generated by, or the like) the same application program.

In yet some other embodiments, each storage server 102 may only store data related to a predefined maximum number of application programs.

In some other embodiments, each storage server 102 may only store data pieces encrypted using the same encryption key.

In some other embodiments, each storage server 102 may only store data pieces encrypted using mutually different encryption keys.

In yet some other embodiments, each storage server 102 may only store data pieces encrypted using a predefined maximum number of different encryption keys.

In some other embodiments, each storage server 102 may only store a same type of data pieces. For example, in one embodiment, each storage server 102 may only store cryptographic keys. In another embodiment, each storage server 102 may store encrypted or unencrypted data and not store any cryptographic keys. In yet another embodiment, each storage server 102 may only store text files. In yet another embodiment, each storage server 102 may only store images.

In yet some other embodiments, each storage server 102 may only store encrypted data pieces and cryptographic keys that are unrelated (that is, the cryptographic keys stored therein cannot be used to decrypt the encrypted data pieces, or to derive decryption keys that can be used to decrypt the encrypted data pieces).

Those skilled in the art will appreciate that, in various embodiments, the one or more characteristics of the data that may be used for selectively storing the data pieces in each storage server 102, such as the examples described above, may be combined as needed. For example, in some embodiments, each storage server 102 may only store a predefined maximum number of data pieces wherein the data pieces may be from, owned by, or related to a predefined maximum number of owners.

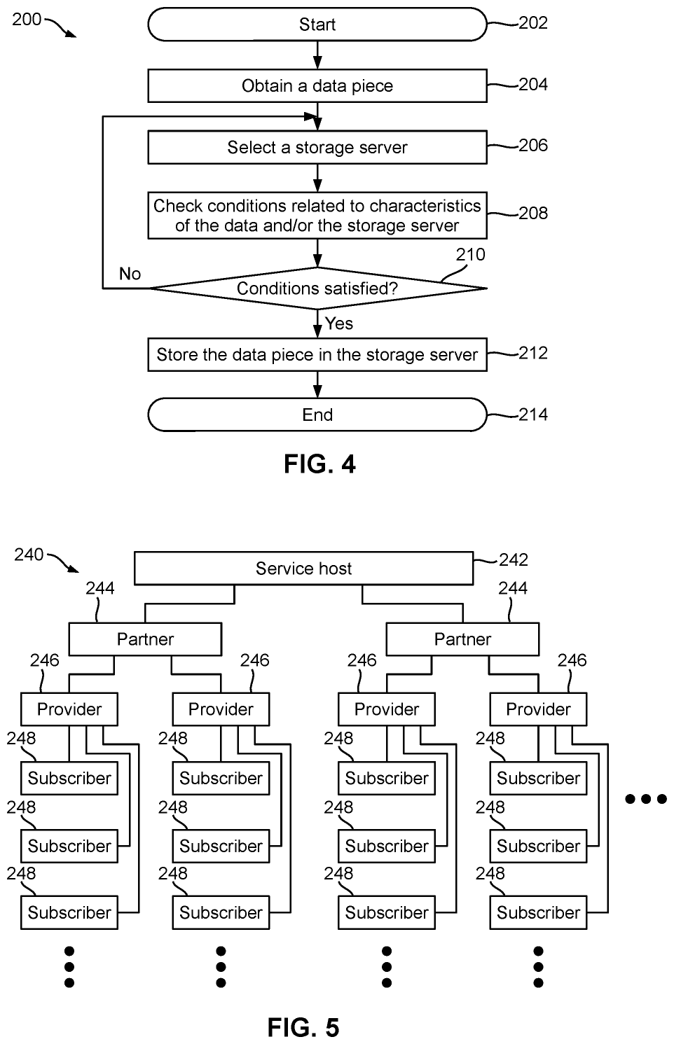

FIG. 4 is a flowchart showing a data-storage process 200 performed by the management server 102′. When the process 200 starts (step 202), the management server 102′ obtains a data piece (step 204), which may be a data piece received from a user, an application, or the like, or may be a data piece such as a cryptographic key generated by the management server 102. At this step, the management server 102′ may process the obtained data piece such as encrypting it.

At step 206, the management server 102′ selects a storage server 102. More specifically, the management server 102′ may randomly select a storage server 102, or select a storage server 102 according to a storage-server management method (described in more detail later).

Then, the management server 102′ checks if the obtained data piece and the selected storage server satisfy one or more conditions (step 210). Such one or more conditions may be based on one or more characteristics of the data and/or the storage server 102 as described above.

If, at step 210, at least one of the one or more conditions is not satisfied, the process 200 then loops back to step 206 for selecting another storage server 206.

If, at step 210, the one or more conditions are satisfied, the management server 102′ sends the data piece to the selected storage server 102 and instruct the storage sever 102 to store the data piece in its memory 102 such as in its storage memory area 172S (step 212), and the process 200 ends (step 214).

In some embodiments, the storage servers 102 are hardware servers. In some other embodiments, at least some of the storage servers 102 may be software storage servers such as virtual servers with enhanced security measures.

The computer network system 100 provides a number of advantages such as:
Isolating mass hacks and cyberattacks: By using a large number of storage servers 102 and limiting the data pieces stored in each storage server 102 based on one or more characteristics, the data stored in each storage server 102 is limited. Therefore, any hacking or cyberattack to a storage server 102 may be confined to that storage server and the damage may be limited, compared to conventional servers that may each store a large amount of data.
Improved scalability: As data are spread to a large number of storage servers 102 (such as hundreds, thousands, or even millions of storage servers) which are preferably low-cost, small-size, and low-power-consumption computing devices, and each storing a limited amount of data (such as one, tens, hundreds, or thousands of data pieces), the computer network system 100 may be easily scaled up or down by adding or removing some storage servers 102, compared to conventional systems that may use a limited number of storage servers (such as one, tens, hundreds, or thousands of storage servers) each storing a large amount of data (such as millions of data pieces).
Lowered per-user or per-data-piece cost when a large number of users use the computer network system 100 for storing their data.

### C. Decentralized Management of Data

In some embodiments, the computer network system 100 organizes the users and storage servers 102 in hierarchical structures for management thereof.

In such hierarchical management structures, each level entails specific service level commitments, operational overheads, and contract terms, each of which may be taken into consideration when implementing the computer network system 100.

FIG. 5 is a schematic diagram showing the hierarchical structure 240 for managing the users and their access rights, data organization, service registration, service discovery, and/or the like.

As shown, the user-management hierarchical structure 240 comprises a plurality of members including a service host 242, one or more partners 244, one or more providers 246, and one or more subscribers 248.

The service host 242, who owns and operates the computer network system 100, is at the top level of the user-management hierarchical structure 240. The service host 242 works directly with one or more partners 244 who are on the second level of the user-management hierarchical structure 240. In these embodiments, each partner 244 may be an entity or organization.

Each partner 244 works directly with one or more providers 246 who are on the third level of the user-management hierarchical structure 240. In these embodiments, each provider 246 may be a department, or group, or affiliate of the partner 244.

Each provider 246 work directly with one or more subscribers 248 who are the users of the computer network system 100 and may (with suitable access rights) store, access, modify, and/or remove data in the computer network system 100.

In the user-management hierarchical structure 240, each higher-level member has the right to manage (that is, to grant, modify, remove, and/or the like) access rights of the lower-level members associated therewith, and monitor the activities thereof. For example, the service host 242 may suspend or remove a partner 244. Consequently, all providers 246 and subscribers 248 associated therewith are also suspended or removed. A partner 244 may suspend or remove a provider 246, and hence all subscribers 248 associated therewith are also suspended or removed. A provider 246 may suspend or remove a subscriber 248 or the client computing-device thereof.

On the other hand, each lower-level member has to register with and be managed by its immediate higher-level member. Generally, a member cannot manage peer or higher-level members.

For example,
a partner 244 has to register with and be managed by the service host 242; a partner is not able to manage other partners;
a provider 246 has to register with and be managed by a partner 244; a provider is not able to manage other providers; and
a subscriber 248 has to register with and be managed by a provider 246 to use the service thereof; a subscriber is not able to manage other subscribers.

In some embodiments, a provider 246 may also be a partner 244, and the service host 242 may also act as a partner 244 or a provider 246.

In some embodiments, the user-management hierarchical structure 240 may comprise more or less levels as needed.

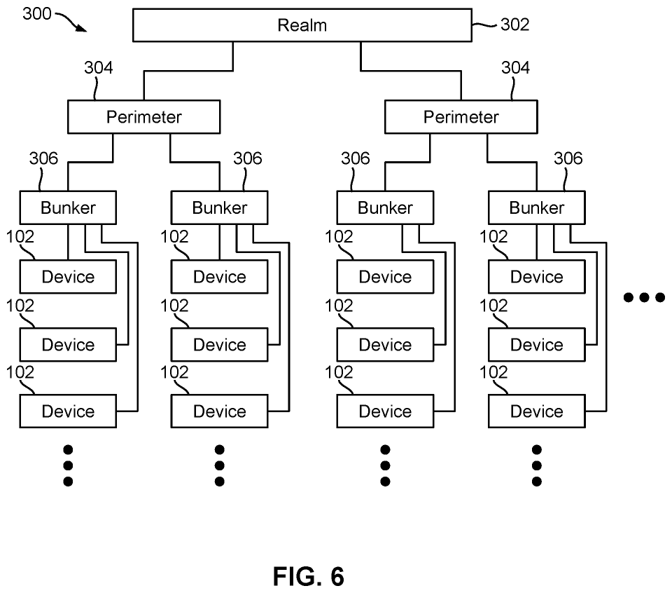

FIG. 6 is a schematic diagram showing the hierarchical structure 300 for managing the storage servers 102 (also denoted “devices” in FIG. 6).

As shown, the device-management hierarchical structure 300 comprises a plurality of nodes including a realm 302, one or more perimeters 304, one or more bunkers 306, and one or more storage servers 102. In these embodiments, these nodes are network domains but may be in any other suitable form in other embodiments. For ease of description, these nodes are also denoted “domains” hereinafter regardless of what form they are in.

The top-level node or domain 302 (denoted “realm”) represents an entity or organization such as a financial institute, a company, a university, or a government, who owns and/or manages and/or operates the computer network system 100. A realm 302 may comprise one or more second-level nodes or domains 304 (denoted “perimeters”). On the other hand, each perimeter 304 may only be associated with one realm 302.

Each perimeter 304 comprises one or more third-level nodes or domains 306 (denoted “bunkers”). On the other hand, each bunker 306 may only be associated with one perimeter 304.

Each bunker 306 comprises one or more fourth-level nodes or domains which are storage servers or devices 102. On the other hand, a storage server 102 may only be associated with one bunker 306.

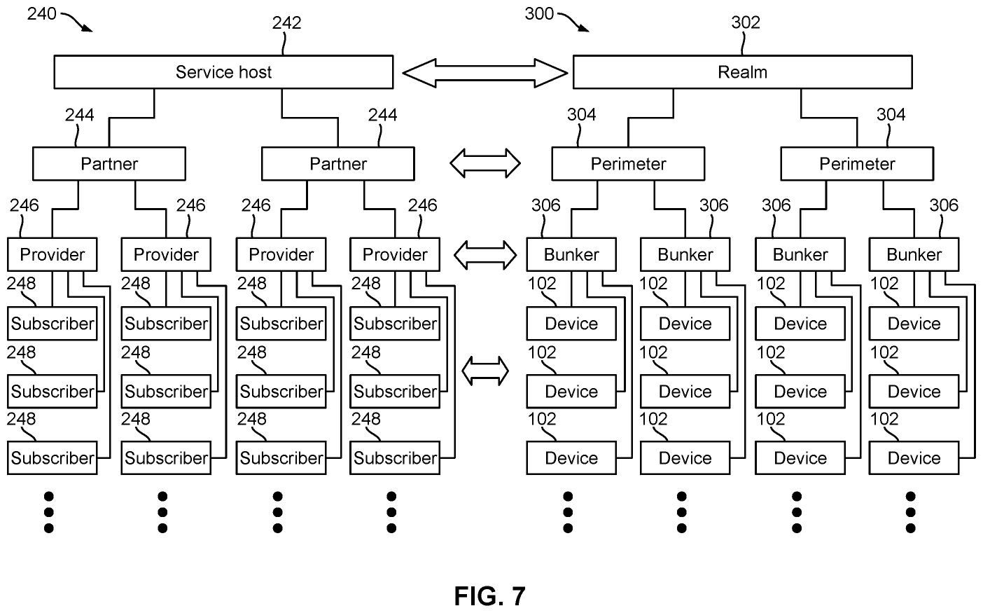

As shown in FIG. 7, the device-management hierarchical structure 300 may map to the user-management hierarchical structure 240. For example,
a partner 244 may request and own one or more perimeters 304 under a realm 302;
a provider 246 associated with a partner 244 may request one or more bunkers 306 under a perimeter 304 associated with the corresponding realm 302 owned by the partner 244;

In some embodiments, a provider 246 may be associated with more than one partners 244. Therefore, such as provider 246 may request one or more bunkers 306 under a perimeter 304 associated with the realm 302 owned by any of the more than one partners 244.

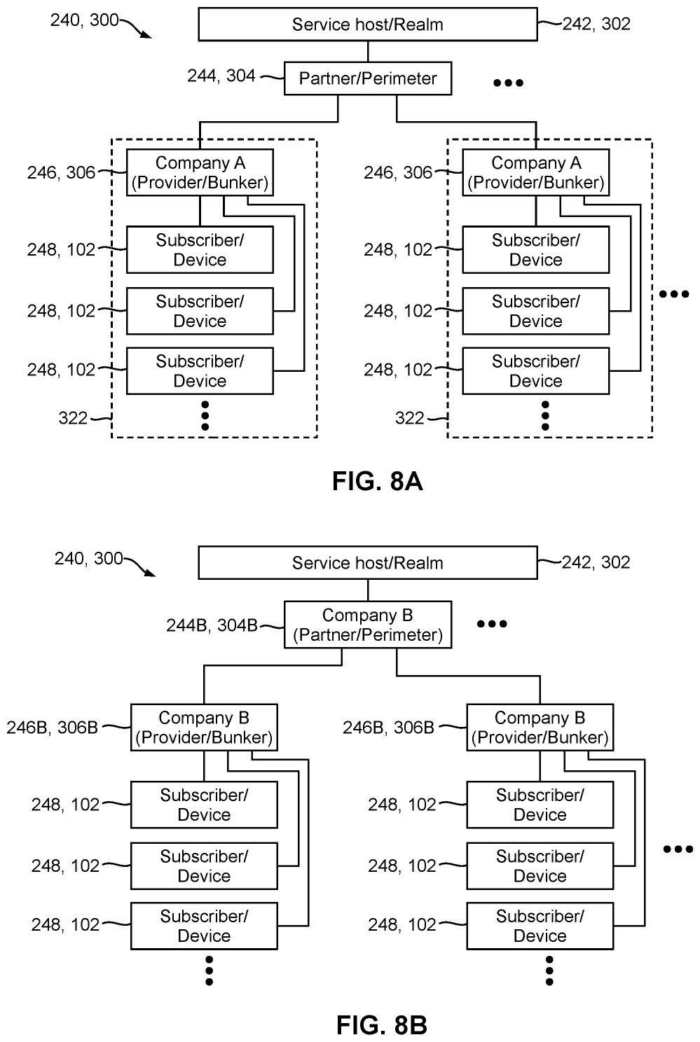

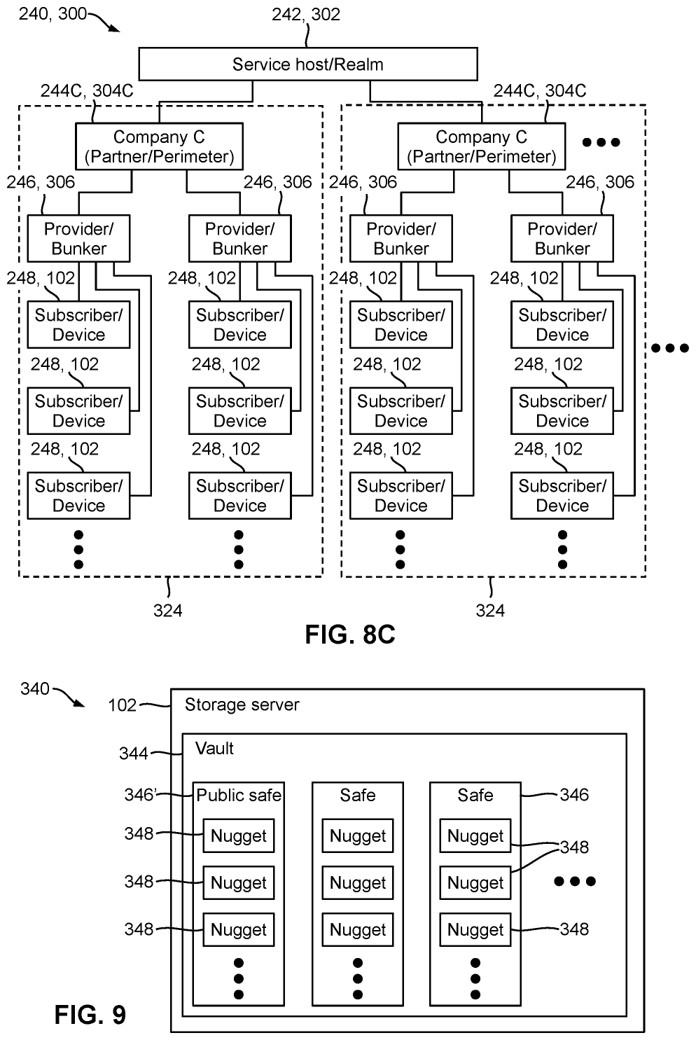

FIGS. 8A to 8C show some examples of the hierarchical structures 240 and 300 for managing the users and storage servers 102.

In the example shown in FIG. 8A, Company A has a plurality of locations 322 across the country. Thus, Company A in this example may act as a plurality of providers 246 and accordingly own a plurality of bunkers 306 corresponding to its locations 322.

In the example shown in FIG. 8B, Company B may be a partner 244B and thus own a perimeter 304B. Company B may also provide storage service via its facilities across the country. Thus, Company B in this example also acts as a plurality of providers 246B associated with itself as the partner 244B, and accordingly owns a plurality of bunkers 306B associated with its perimeter 304B.

In the example shown in FIG. 8C, Company C operates in a plurality of countries. Then, Company C may act as a plurality of partners 244C and thus own a plurality of perimeters 304C each in a respective country 324. Each perimeter 304C comprises a plurality of bunkers 306 with one for each physical location that Company C has a hosting center therein.

In some embodiments, realm trusts may be formed or otherwise established between different service hosts 242 when needed. In these embodiments, realm trusts may only allow queries between service hosts 242, and a realm cannot be managed by another realm. Such realm trusts may be permanent, for a limited time period, and/or under any other suitable conditions. Moreover, the realm trusts may only allow specific types of queries.

For example, several major financial institutions each having their own realm may need to establish realm trusts therebetween to allow queries between their respective systems.

In these embodiments, trusts between partners of different realms are not allowed. However, trusts between partners of the same realm may or may not be allowed, and such trusts may be permanent, for a limited time period, and/or under any other suitable conditions, depending on the implementation.

In these embodiments, trusts between providers of different realms are not allowed. However, trusts between providers of the same partners, or trusts between providers of different partners of the same realm may or may not be allowed, and such trusts may be permanent or for a limited time period, depending on the implementation.

FIG. 9 is a schematic diagram showing a hierarchical structure 340 for managing data stored in each storage server 102. As shown, the hierarchical structure 340 comprises a vault 344, safes 346, and nuggets 348 in different levels. In various embodiments, some or all of the vault 344, safes 346, and nuggets 348 may be encrypted.

Each storage server or device 102 has a globally unique identifier (ID) in the computer network system 100, and is used to host secrets, manage them, and respond to query requests. The storage server 102 comprises a data structure or data container 344 denoted “vault”. Each of the vaults 344 has a globally unique ID in the computer network system 100. In these embodiments, each storage server 102 has only one vault 344. However, a vault 344 may be replicated to a plurality of storage servers 102 for redundancy or load balancing. Each vault 344 has its own authorization and authentication mechanism for management and comprises one or more data substructures or data sub-containers 346 denoted “safes”. A vault 344 may comprise any suitable number of safes 346.

Each safe 346 has a globally unique ID in the computer network system 100 and comprises one or more data structures 348 denoted “nuggets” each for storing one of the one or more data pieces. In these embodiments, the vault 344 also comprises a public safe 346′ allowing all clients and their applications to query the nuggets 348 stored therein.

In these embodiments, various types of safes 346 may be used including, for example, secure safe (or simply denoted “safe”) that may be privately owned by a subscriber 248, public safe that the “public” or multiple users/apps may access the nuggets stored therein (if they know the nugget ID), and linked safe that only contains linked nuggets (described later). In some embodiments, nuggets in a linked safe cannot be registered for discovery.

In these embodiments, safes 346 (including the public safe 346′) are organizational units used to group and authorize access to secrets or data pieces (that is, the nuggets 348) based on logical access constructs. Access to a safe 346 means access to all nuggets 348 stored therein. Such access may be in the form of query-only, or delegated access (that is, partial management including limited read, write, and modify rights), or subscriber-level full access (including full read, write, and modify rights). A safe 346 may comprise any suitable number of nuggets 348.

In some embodiments where the storage server 102 is assigned to, owned by, or otherwise associated with a single subscriber 248, the vault 344, safes 346, and nuggets 348 in the storage server 102 are all owned by the subscriber 248. In some other embodiments where the storage server 102 may be shared by a plurality of subscribers 248, the vault 344 is shared by these subscribers 248 and each of these subscribers 248 may privately own one or more safes 346 in the vault 344 for storing their nuggets 348. Thus, in the computer network system 100, each nugget 348 is owned by a respective subscriber 248, who has full access to the nugget and may grant other subscribers the access thereto. Without the owner's granting of access, any other members (including the service host 242, the partners 244, the providers 246, and other subscribers 248) cannot access the owner's nuggets 348 (even in the encrypted form).

In these embodiments, each nugget 348 has a globally unique ID in the computer network system 100. A nugget contains the actual secret a user tries to protect. A Nugget may be any piece or type of digital information or digital asset. Examples include encryption keys, decryption keys, images, documents, NFTs, blockchain keys, PDF files, scanned contracts, zip files, and the like.

In some embodiments, various types of nuggets 348 may be used including, for example, normal nugget (also called “regular nugget”), linked nugget, and linking nuggets. Once a nugget type is set, it cannot be changed.

A normal nugget is generally a secret or data piece of any suitable data type, such as cryptographic keys, images, documents, a NFT, a blockchain key, a contract, a zip file, or the like. A normal nugget may comprise its own metadata. Normal nuggets can be registered for discovery.

A linked nugget is similar to a normal nugget (that is, containing a secret and having metadata associated therewith). However, unlike a normal nugget, a linked nugget cannot be accessed directly. It can only be accessed via a linking nugget. A safe that contains a linked nugget can only contain linked nuggets, and cannot contain normal nuggets or linking nuggets, for preventing the possibility of inadvertently sharing nuggets that should not have been shared via “normal” means. Linked nuggets cannot be registered for discovery.

A linking nugget comprises a link pointing to a linked nugget (in other words, linking to a secret that resides within that linked nugget), and may also comprise its own metadata. In other words, the structure and behavior of a linking nugget are similar to those of a normal nugget except that the secret of the linking nugget refers to or “links” to the secret of a linked nugget. A safe may contain both linking nuggets and normal nuggets. However, linking nuggets and linked nuggets cannot be stored in the same safe. Linking nuggets can be registered for discovery.

In some embodiments, a linking nugget must link to a linked nugget, and cannot link to any normal nugget.

In some embodiments, a linking nugget must link to a linked nugget within the same vault, and cannot link to any normal nugget.

In some embodiments, a linking nugget must link to a linked nugget outside its own safe.

In some embodiments, the secret of a linking nugget cannot be updated or modified as the linking nugget does not contain the actual secret. The secret of a linking nugget can only be modified by updating the secret contained in the linked nugget that the linking nugget points to.

In some embodiments, a linked nugget comprises or is associated with a link counter having a default value such as zero (0). When a linked nugget is linked to a linking nugget, the link counter of the linked nugget is incremented by one (1). When a linking nugget is deleted, the link counter of the associated linked nugget is decremented by one (1). A linked nugget cannot be deleted until its link counter reaches the default value such as zero (0).

With above characteristics, the use of linked and linking nuggets provides a powerful mechanism to share “common” secrets between unrelated entities with high scalability and without compromising security measures.

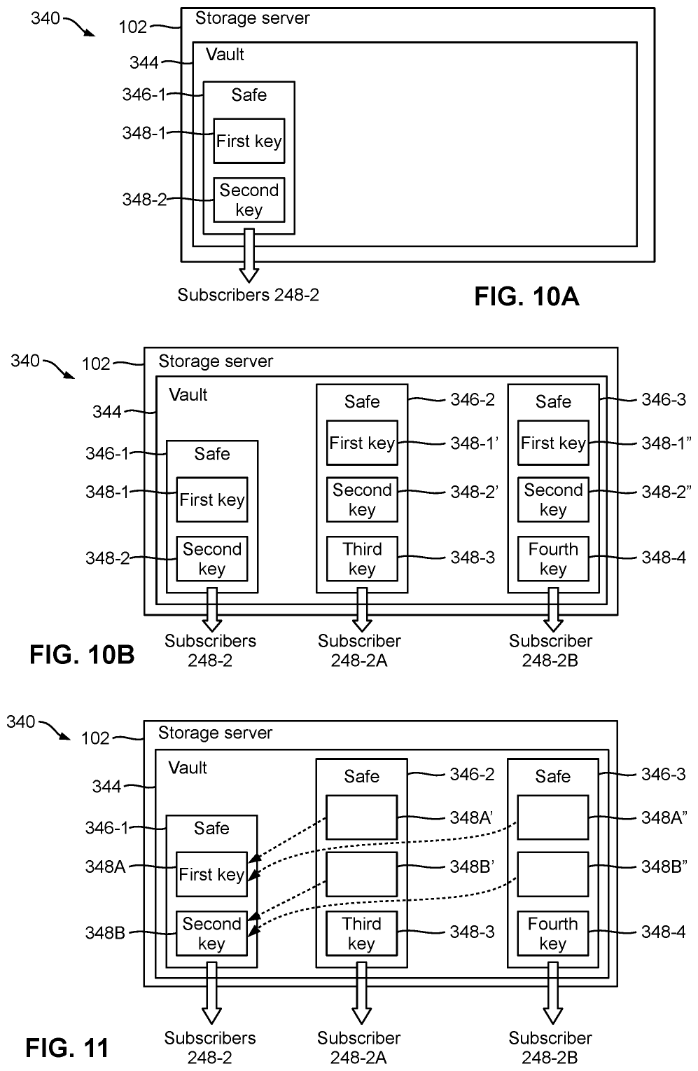

For example, as shown in FIG. 10A, a subscriber 248-1 has two encrypted documents decryptable using a first decryption key and a second decryption key, respectively. The subscriber 248-1 wants to share these documents with a plurality of other subscribers 248-2, which may be done by sharing the first and second decryption keys with each of the plurality of other subscribers 248-2.

In this example, the subscriber 248-1 may create a safe 346-1 in the vault 344 of a storage server 102 storing therein a normal nugget 348-1 storing the first decryption key and a normal nugget 348-2 storing the second decryption key, and then share the normal nuggets 348-1 and 348-2. In particular, the subscriber 248-1 may grant subscribers 248-2 the access to the nuggets 348-1 and 348-2, and send to subscribers 248-2 the IDs of the nuggets 348-1 and 348-2. Then, each subscriber 248-2 has the access to the safe 346-1, all nuggets 348-1 and 348-2 stored in the safe 346-1, and the first and second decryption keys stored in the nuggets 348-1 and 348-2.

Now, if the subscriber 248-1 want to share a third decryption key to a first one of the subscribers 248-2 (denoted 248-2A) and a fourth decryption key to a second one of the subscribers 248-2 (denoted 248-2B), the subscriber 248-1 cannot add the third and fourth decryption keys (or the nuggets storing the second and third decryption keys) to the safe 346-1, because then all subscribers 248-2 would have the access to the third and fourth decryption keys.

As shown in FIG. 10B, in embodiments where the linking and linked nuggets are not used, the subscriber 248-1 may create another safe 346-2 storing therein a copy of the normal nuggets 348-1 and 348-2 (denoted 348-1′ and 348-2′ which store the first and second decryption keys, respectively), and a normal nugget 348-3 storing the third decryption key, and grant the subscriber 248-2A the access to the safe 346-2. Similarly, the subscriber 248-1 may create another safe 346-3 storing therein a copy of the normal nuggets 348-1 and 348-2 (denoted 348-1″ and 348-2″ which store the first and second decryption keys, respectively), and a normal nugget 348-4 storing the fourth decryption key, and grant the subscriber 248-2B the access to the safe 346-3.

As shown in FIG. 10B, the subscriber 248-1 now has created three safes 346-1 to 346-3, wherein safe 346-1 stores the first and second decryption keys, safe 346-2 stores the first, second, and third decryption keys, and safe 346-3 stores the first, second, and fourth decryption keys.

Then, if the subscriber 248-1 needs to change, for example, the first decryption key which has three copies stored in three normal nuggets 348-1, 348-1′, and 348-1″ in three safes 346-1 to 346-3, the subscriber 248-1 has to change the first decryption key in all three normal nuggets 348-1, 348-1′, and 348-1″ in three safes 346-1 to 346-3, which means that the subscriber 248-1 has to remember which safes and which nuggets need to be updated. When a large number of safes and/or nuggets are involved, this scenario may cause a significant burden to the subscriber 248-1, and may be easy to experience errors.

In embodiments where linking and linked nuggets are used, the above-described issues may be alleviated or even eliminated.

For example, as shown in FIG. 11, the subscriber 248-1 may create a safe 346-1 containing linked nuggets 348A and 348B storing the first and second decryption keys, respectively, for sharing with subscribers 248-2. The subscriber 248-1 may create a safe 346-2 for the subscriber 248-2A containing linking nuggets 348A′ and 348B′ linking to the linked nuggets 348A and 348B, respectively, and a normal nugget 348-3. The subscriber 248-1 may create a safe 346-2 for the subscriber 248-2A containing linking nuggets 348A′ and 348B′ linking to the linked nuggets 348A and 348B, respectively, to allow the subscriber 248-2A to access the decryption keys stored in the linked nuggets 348A and 348B, and a normal nugget 348-3 storing the third decryption key. The subscriber 248-1 may also create a safe 346-3 for the subscriber 248-2B containing linking nuggets 348A″ and 348B″ linking to the linked nuggets 348A and 348B, respectively, to allow the subscriber 248-2A to access the decryption keys stored in the linked nuggets 348A and 348B, and a normal nugget 348-4 storing the fourth decryption key.

To update the first and second decryption keys, the subscriber 248-1 only needs to update them in the first safe 346-1 (that is, updating the linked nuggets 348A and 348B). The update is automatically reflected in safes 346-2 and 346-3 through the linking nuggets stored therein.

When, for example, the right of the subscriber 248-2B to access the liked nugget 348A needs to be revoked, the subscriber 248-1 may simply remove the linking nugget 348A″ in safe 346-3, which invalidates the ID of the linking nugget 348A″. Alternatively, the subscriber 248-1 may remove the safe 346-3, which automatically removes the linking nugget 348A″ stored therein. The access rights of subscriber 248-2A are not affected by revoking the access right of the subscriber 248-2B.

Those skilled in the art will appreciate that a subscriber having access to a linking nugget in a safe can only access the associated linked nugget that the linking nugget is linked to, and does not automatically grant the access to other nuggets in the same safe of linked nugget.

### D. Implementation

This subsection describes some implementation details of the computer network system 100.

### D-1. User-Management Member Registrations

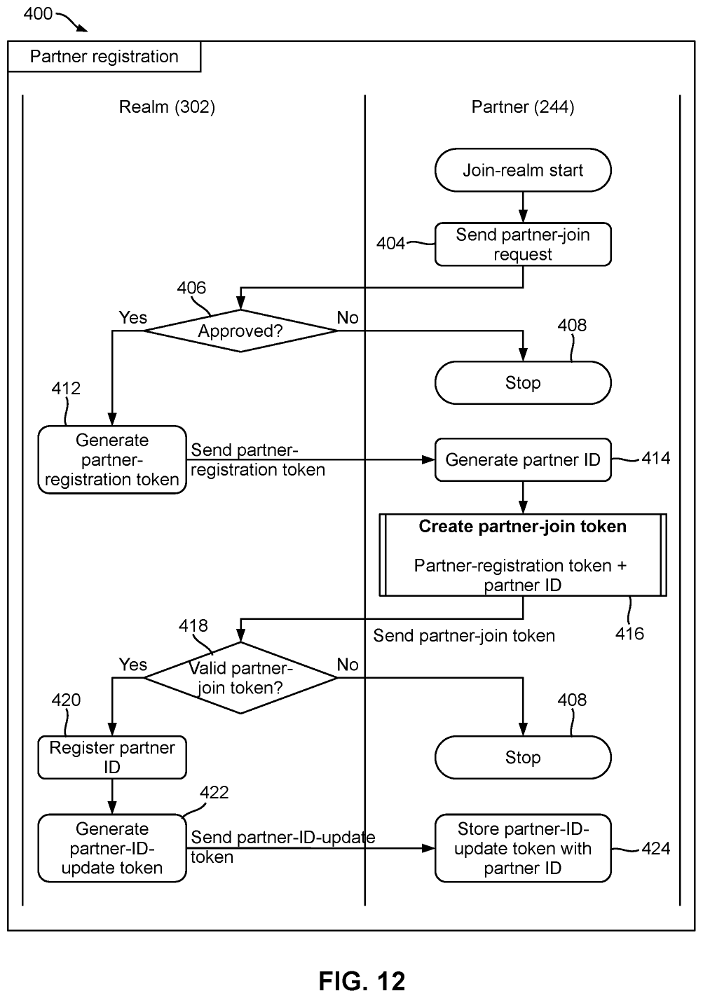

FIG. 12 is a flowchart showing a partner-registration process 400 for a new partner 244 to join a realm 302 (or more specifically, to register under the corresponding service host 242).

At step 404, the partner 244 sends a partner-join request to the realm 302. If the owner of the realm 302 (that is, the service host 242, or more specifically, a user (such as an administrator) of the service host 242) does not approve the request (the “No” branch of step 406), the process 400 is then terminated (step 408).

If the service host 242 approves the request (the “Yes” branch of step 406), the realm 302 generates a one-time partner-registration token and sends it to the partner 244 (step 412). The partner 244 generates a partner-ID (step 414). Then, the partner 244 creates a partner-join token comprising the partner-ID and the partner-registration token, and sends the partner-join token to the realm 302 (step 416).

At step 418, the realm 302 verifies the validity of the partner-join token by comparing the partner-registration token the realm 302 sent to the partner 244 with that in the partner-join token received from the partner 244. If the partner-join token is invalid (the “No” branch of step 418), the process 400 is terminated (step 408).

If the partner-join token is valid (the “Yes” branch of step 418), the new partner-ID for the partner 244 is registered in the realm 302 (step 420). The realm 302 then generates a partner-ID-update token and sends it to the partner 244 (step 422). The partner 244 receives the partner-ID-update token, stores it with the partner ID, and uses the information therein to join the realm 302 (step 424). The partner-registration process 400 then ends.

In some embodiments, the partner-ID-update token is further used to make any updates (such as name changes, and/or the like) to the partner information stored at the realm.

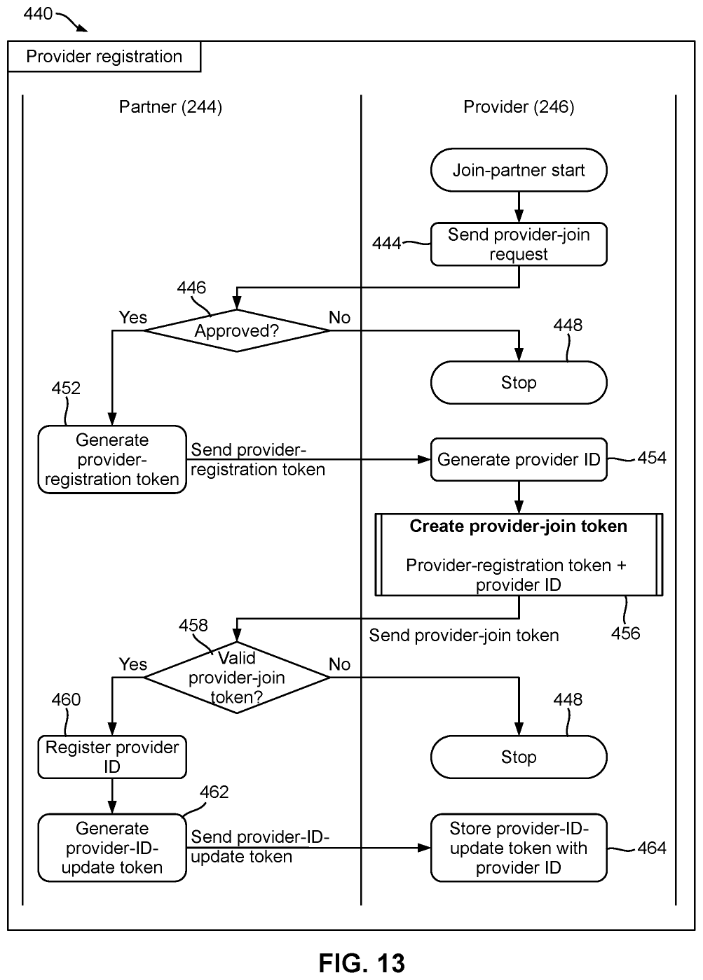

FIG. 13 is a flowchart showing a provider-registration process 440 for a new provider 246 to join a realm 302 (or more specifically, to register under a partner 244).

At step 444, the provider 246 sends a provider-join request to the partner 244. If the partner 244 (or more specifically, a user (such as an administrator) of the partner 244) does not approve the request (the “No” branch of step 446), the process 440 is then terminated (step 448).

If the partner 244 approves the request (the “Yes” branch of step 446), the partner 244 generates a one-time provider-registration token and sends it to the provider 246 (step 452). The provider 246 generates a provider-ID (step 454). Then, the provider 246 creates a provider-join token comprising the provider-ID and the provider-registration token, and sends the provider-join token to the partner 244 (step 456).

At step 458, the partner 244 verifies the validity of the provider-join token by comparing the provider-registration token the partner 244 sent to the provider 246 with that in the provider-join token received from the provider 246. If the provider-join token is invalid (the “No” branch of step 458), the process 440 is terminated (step 448).

If the provider-join token is valid (the “Yes” branch of step 458), the new provider-ID for the provider 246 is registered in the partner 244 (step 460). The partner 244 then generates a provider-ID-update token and sends it to the provider 246 (step 462). The provider 246 receives the provider-ID-update token, stores it with the provider ID, and uses the information therein to join the realm 302 under the partner 244 (step 464). The provider-registration process 440 then ends.

In some embodiments, the provider-ID-update token is further used to make any updates (such as name changes, and/or the like) to the provider information stored with the partner.

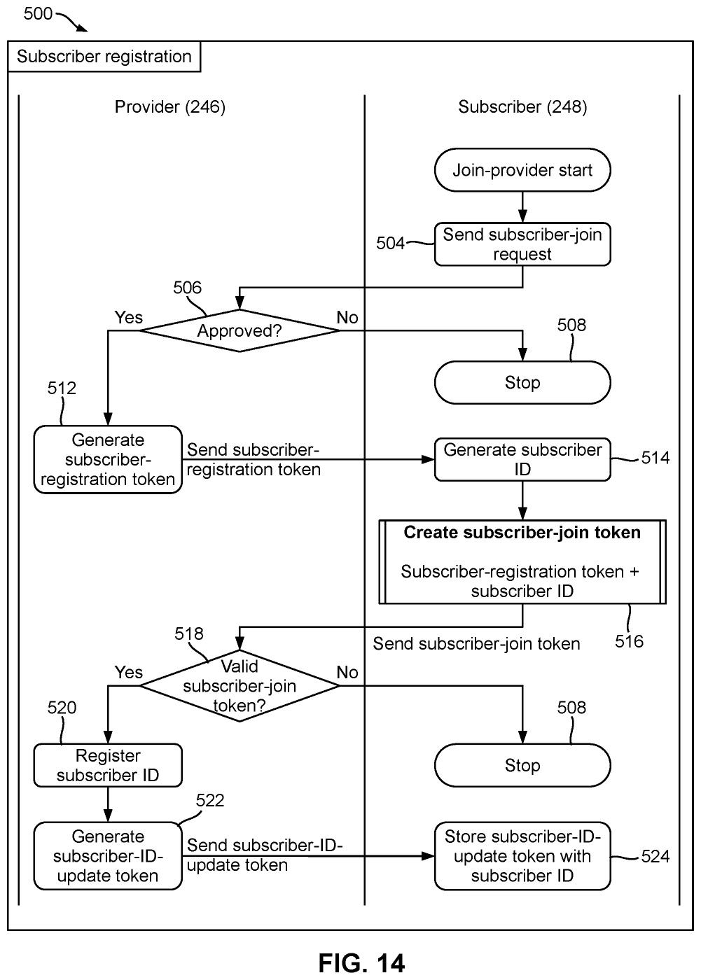

FIG. 14 is a flowchart showing a subscriber-registration process 500 for a new subscriber 248 to join a realm 302 (or more specifically, to register under a provider 246).

At step 504, the subscriber 248 sends a subscriber-join request to the provider 246. If the provider 246 (or more specifically, a user (such as an administrator) of the provider 246) does not approve the request (the “No” branch of step 506), the process 500 is then terminated (step 508).

If the provider 246 approves the request (the “Yes” branch of step 506), the provider 246 generates a one-time subscriber-registration token and sends it to the subscriber 248 (step 512). The subscriber 248 generates a subscriber-ID (step 514). Then, the subscriber 248 creates a subscriber-join token comprising the subscriber-ID and the subscriber-registration token, and sends the subscriber-join token to the provider 246 (step 516).

At step 518, the provider 246 verifies the validity of the subscriber-join token by comparing the subscriber-registration token the provider 246 sent to the subscriber 248 with that in the subscriber-join token received from the subscriber 248. If the subscriber-join token is invalid (the “No” branch of step 518), the process 500 is terminated (step 508).

If the subscriber-join token is valid (the “Yes” branch of step 518), the new subscriber-ID for the subscriber 248 is registered in the provider 246 (step 520). The provider 246 then generates a subscriber-ID-update token and sends it to the subscriber 248 (step 522). The subscriber 248 receives the subscriber-ID-update token, stores it with the subscriber ID, and uses the information therein to join the realm 302 under the provider 246 (step 524). The subscriber-registration process 500 then ends.

In some embodiments, the subscriber-ID-update token is further used to make any updates (such as name changes, and/or the like) to the subscriber information stored with the provider.

### D-2. Data and Communications

In some embodiments, the data in a nugget 348 may be in the base64url format; see RFC 4648(5) at https://datatracker.ietf.org/doc/html/rfc4648#section-5. In other words, before a data piece is stored in a nugget 348, it needs to be converted or encoded to base64url (with optional omission of any base64 padding (see https://datatracker.ietf.org/doc/html/rfc4648#section-3.2).

The base64url format allows virtually any type of digital information or digital asset (such as a key, a file, an NFT, a PDF scan, and/or the like) to be stored in the nugget 348. Accordingly, when a secret or data piece is queried by a subscriber 248 or an application program thereof, the secret or data piece may need to be decoded or converted from base64url back to its original format.

The subscribers 248 (also called the “subscriber stack”) perform the core of the functions on a storage server 102 including the setup, configuration, storing, and/or querying of elements within the vault 344. The subscribers 248 also log all events, all access, all potential cyber threats, and the like, and activate cyber counter-measures to prevent cyberattacks.

In some embodiments, all communications between the subscribers 248 and data-access requests are optionally multi-encrypted.

For example, transport layer security (TLS) certificates may be used to encrypt traditional hypertext transfer protocol secure (HTTPS), representational state transfer (REST) and domain name system (DNS) traffic for communications between an application program and a device 102. Any suitable cipher technologies, for example any of the industry accepted secure or recommended cipher suites such as TLS AES 128 CCM 8 SHA256, TLS AES 128 CCM SHA256, ECDHE-ECDSA-AES256-SHA, and/or the like may be used. In addition, the application program and the device 102 may also exchange additional element-level certificates to further encrypt the communications within the HTTPS session, thereby resulting in multi encryption.

In some embodiments, authentication is used for communications involving a device 102, which may be, for example, secure sockets layer (SSL) authentication between an application program and a storage server 102, or SSL authentication between two storage servers 102.

In some embodiments, peer-to-peer connection with full encryption may be used for direct communication between an application program (or a client computing-device 104) and a vault 344. Such a peer-to-peer connection may use the interactive connectivity establishment (ICE) technique with full encryption.

In some embodiments, encrypted DNS queries (for example, encrypted using DNSCrypt, DNS over HTTPS (DoH), DNS over TLS (DOT), or the like) may be used to query secrets from the computer network system 100.

### D-3. Elements

Each element of the computer network system 100, including the service host 242, partner 244, provider 246, subscriber 248, realm 302, perimeter 304, bunker 306, storage server 102, vault 344, safe 346, and nugget 348, needs to have a method of identification. Accordingly, each element may have a unique ID.

In some embodiments, each element comprises a plurality of fields including:
an ID;
a label;
a hash;
a registration state;
a cipher or encryption type;
one or more customized attributes; and
one or more element-specific parts which may vary depending on the element type.

The detail of each field is described as follows.

### Element ID:

An element ID is a cryptographically secure, random, 200-bit or other significant bit value which is unique within and across the entire realm 302.

TABLE 1
EXAMPLE OF A 200-BIT NUMBER ENCODED IN VARIOUS FORMATS.

Binary:
0011110001111010110001101100101001111010000011100001011111011000010010000110111110
0111110010110011111000000100111000100010100101100101001111101111011011101111101100
000110101110000101110001001110111010
Decimal: 379636575806845603295140467934723641935194257659305223721914 (*)
Hex: 3c7ac6ca7a0e17d8486f9f2cf81388a594fbdbbec1ae1713ba
Base32: 7hxcdjkt1rbxgj3fkwpfg4w8mpafqpxyr6q1e4xt
Base58: RLUNf9wcLWkzeUCxcbnravGvD64767i4G1
Base64url: PhrGynoOF9hIb58s-BOIpZT7277BrhcTug
(*) In English −> 379 ocodecillion, 636 septendecillion, 575 sexdecillion, 806 quindecillion, 845 quattuordecillion, 604 tredecillion, 295 duodecillion, 140 undecillion, 467 decillion, 934 nonillion, 723 octillion, 641 septillion, 935 sextillion, 194 quintillion, 257 quadrillion, 659 trillion, 305 billion, 223 million, 721 thousand, 9 hundred and 14.

When an element ID is represented as a text string using an encoding format, the obtained text string needs to meet two criteria in order to allow the option of retrieval of secrets using DNS:
the text string must only contain valid DNS characters; and
the text string must be short enough to use in a fully qualified domain name (FQDN).

Among the encoding formats shown in Table 1, Hex representation may be used to obtain a text string of a short length. However, while it uses valid DNS characters, it may result in names that are too long for the DNS standard to use. Base58 (as used in bitcoin) and Base64url use characters that are not valid in a DNS name, and thus cannot be used for encoding the element ID.

Base32 is a representation that results in a text string of a short length for the DNS standard, and only has valid characters in DNS names. Thus, Base32 format may be used for encoding the element ID. More specifically, Crockford Base32 may be used to minimize the ambiguity of certain characters (for example, number “1” (one) vs letter “I” (lower-case “L”), number “0” (zero) vs letter “O”). Each value in the Base32 character set is 5-bit long. Thus, by using the Base32 format, a 200-bit binary number may be encoded into 40 Base32 characters. On the other hand, a 256-bit binary number may need padding to convert to a Base32 text string.

As no elements in the computer network system 100 have the same ID, the identification of various elements is simple and easy. Application programs may also need to access secrets or data pieces stored in the storage servers 102. Therefore, application programs also have unique IDs and properties.

Generally, the vast majority of activity is querying a nugget by a query initiator (being a subscriber or an application program thereof) for its content. In some embodiments, two methods may be used for querying a nugget 348:
1) using the nugget ID to search the storage servers 102 and returning the content of the nugget 348.
2) using the ID of the query initiator to search the storage servers 102 and returning a list of nuggets that the query initiator has been granted access thereto. Then, using the nugget ID to search the returned list of nuggets.

In some embodiments, the ID of each element may comprise a prefix for ease of identifying the type of the element. Table 2 shows some examples of the prefixes.

TABLE 2
EXAMPLES OF ELEMENT PREFIXES

| Element | Prefix |
|---|---|
| Device/storage server | dv |
| Vault | vt |
| Safe | sf |
| Nugget | ng |
| Perimeter | pm |
| Bunker | bk |
| Subscriber | ss |
| Application program | ap |
| License | lc |

In these embodiments, an element ID may be in the form of:
<element prefix>-<value>
   where “<element prefix>” represents the element prefix (see Table 2), and “<value>” represents the above-described, randomly generated element ID value. In these embodiments, hyphen (“-”) is used as the connector between the element prefix and element ID value because it is a valid character in domains used for SSL certificates. On the other hand, underscore (“_”) cannot be used in these embodiments because it is no longer a valid character in domains used for SSL certificates; see CAB SC12 Sunset of Underscores in DNSNames (https://cabforum.org/2018/11/12/ballot-sc-12-sunset-of-underscores-in-dnsnames/).

For example, a 200-bit value is randomly generated as (represented in Base32 format):
bv4detd3dbhtqsw5v3dz550f5t561mr56g0y1cfq

If this value is used as the element ID value of a device 102, the device ID is then:
dv-bv4detd3dbhtqsw5v3dz550f5t561mr56g0y1cfq

If this value is used as the element ID value of a safe 346, the safe ID is then:
sf-bv4detd3dbhtqsw5v3dz550f5t561mr56g0y1cfq

### Element Label:

The element label is optional. In embodiments where the element label is used, the element label may comprise a text string for identifying the elements. Labels may not be unique, and thus a plurality of elements may have the same label.

For example, a vault 344 may comprise two safes 346 with labels “Annie01” and “Bob04”, respectively, which may allow the subscriber 248 to easily identify the difference between those two safes 346. As another example, a safe 346 may comprise three (3) nuggets 348. One of the nuggets 348 may have the label “Panther” and the other two nuggets may have the label “Rabbit”.

### Element Hash:

An element may comprise a hash of the element ID and/or other fields of the element, which may allow the computer network system 100 to register an ID with the upstream registry servers of the element, without providing the actual name of the element. Herein, the term “upstream of a first element” refers to the “parent”, upper-level element the first element belonging thereto or associated therewith.

By using the element hash, the actual name of the element is “hidden” from possible prying eyes, thereby preventing possible mass “guessing” of element names and providing an additional level of security. In some embodiments, the hash may be SHA3-256 and may be displayed in Base32 (which results in a 52-character value).

### Element Registration State:

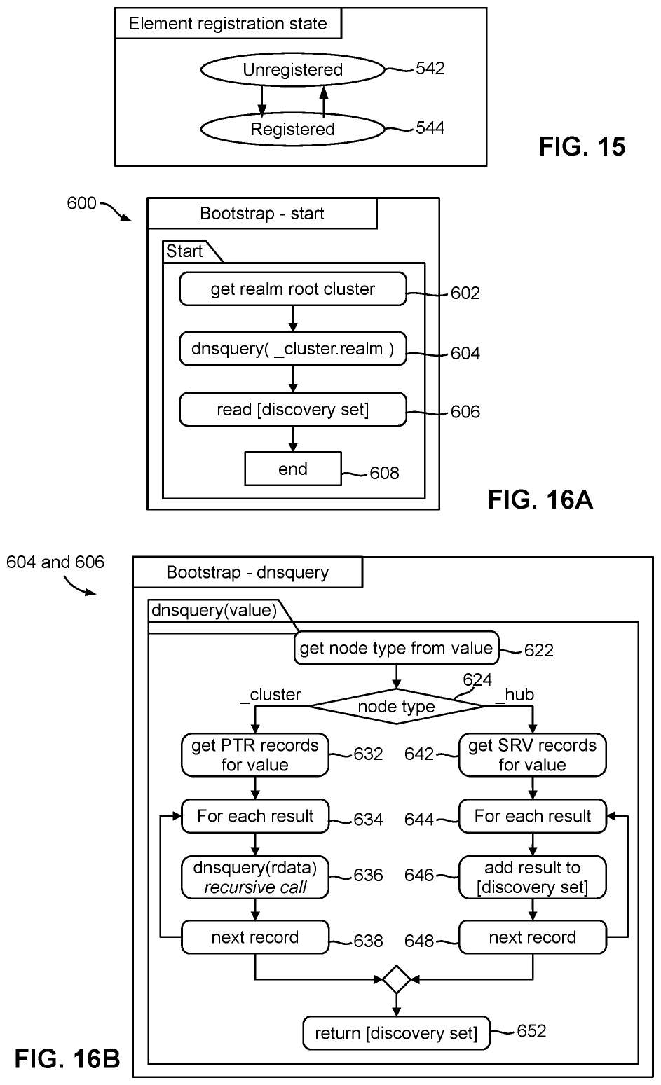

As shown in FIG. 15, an element may be in one of the following registration states:
Unregistered 542 (that is, the element is not registered); and
Registered 544 (that is, the element is registered).

These states follow the service registration state of the element. When an element is created, its registration state is unregistered 542 (meaning not registered). Once the element is registered as a part of service registration for service discovery, its state changes from unregistered 542 to registered 544. An element's state may change between unregistered and registered as many times as required.

### Element Cipher or Encryption Type:

In addition to the standard TLS-certificate based encryption provided by REST (HTTPS) and DNSCrypt/DoH/DoT, each element may optionally allow further encryption (indicated by the element's encryption type field) for communications, which provides a very strong and secure multi encryption mechanism for all connections. The encryption types may be customizable depending on required security levels and applicable encryption restrictions based on geopolitical location of a device. For example, in some embodiments, AES-256 or ChaCha20may be used for such further encryption. In other embodiments, post-quantum cryptography such as lattice-based cryptography (for example, NTRU) and code-based cryptography (for example, the McEliece cryptosystem) may be used.

If the encryption type field of an element is not set, the encryption types are inherited from the parent element.

### Element Customized Attributes:

A customized attribute allows a subscriber or a designated application program to assign a customized label/value pair to an element. The label/value pair may be used as a tag or a category for helping users to organize and advertise in querying for elements of a specific type or label.

In some embodiments, two element types, that is, safe and nugget, support customized attributes (such as up to 16 customized attributes). An attribute may be a private attribute or a public attribute. Moreover, an attribute may be toggled between private and public.

Private attributes are only viewable by the owner/subscriber of the element, and are not published, advertised, or queryable by the service discovery process.

Public attributes are generally viewable and queryable by those who have the required authorization. For example, a public attribute of a safe 346 is viewable, and queryable by the authorized public, thereby allowing an application program to focus results on a specific set or subset of a result set. Therefore, once a user is authorized to have the access to a safe 346, the user also has the access to all information in that safe 346 (except the private attributes).

### D-4. Bootstrap and Registry

### Bootstrap:

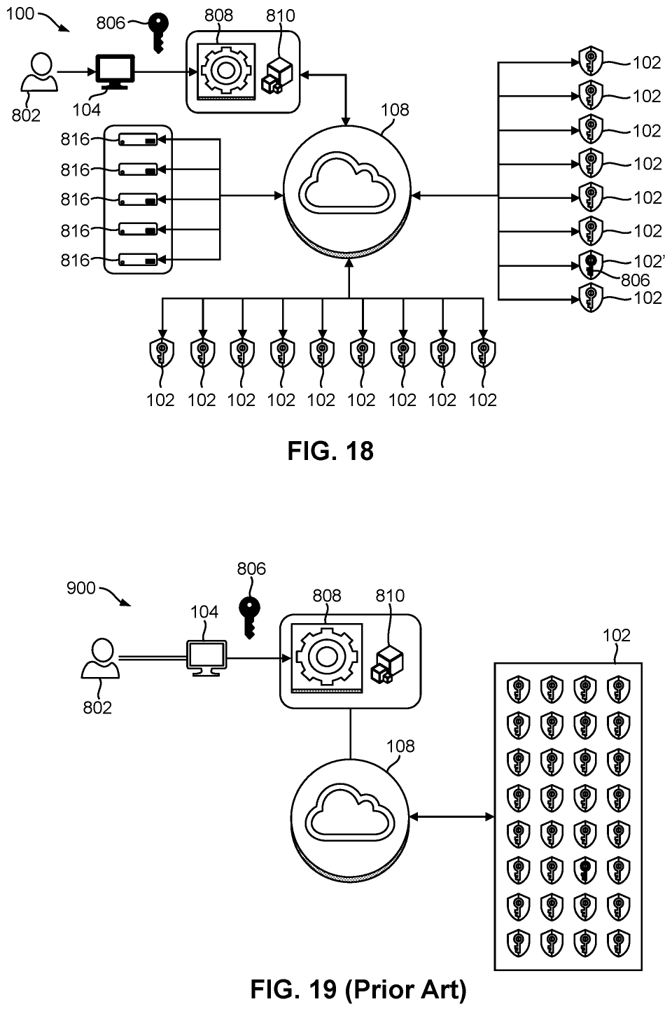

In some embodiments, a bootstrap process is used, which is important to the scalability of the system 100, and allows virtually an unlimited number of devices 102 to participate in the system's ability to discover where an element is located. In order to determine “which” devices hold “which” secrets, the bootstrap process builds a discovery list containing a list of discovery servers or devices 816 (see FIG. 18; described in more detail later), wherein the devices 816 in the list are the servers 816 that the actual discovery queries are sent to.

In some embodiments, a cluster/hub lookup hierarchy methodology is used to build the bootstrap topology, which allows for massive scalability, redundancy/resiliency, and customization of service locations. The following lists the definition of some terms in order to properly describe the bootstrap process:
A node is either a cluster or a hub.
A cluster is a collection of sub-clusters and/or hubs.
A hub is a collection of discovery servers.
A discovery server provides a discovery service.

In these embodiments, the bootstrap process uses the following bootstrap rules:
1. Cluster names always start with “_cluster”.
2. Hub names always start with “hub”.
3. Cluster lookups always use a DNS pointer (PTR) record lookup, which means that, in the bootstrap process, when encountering a name starting with “_cluster”, a DNS PTR lookup on that node needs to be performed, which generally returns a list of sub-clusters, or a list of hubs for that cluster, or a combination of both.
4. Hub lookups always use a DNS service (SRV) record lookup, which means that when encountering a node that starts with “_hub”, a DNS SRV lookup on that node needs to be performed, which generally returns a list of discovery servers for that hub, in standard SRV record format.
5. Discovery server lookups follow the normal rules for A/AAAA record lookups.

Those skilled in the art will appreciate that querying the same cluster record shall not be more than once in the same lookup thread as this may result in a cyclical reference.

FIG. 16A shows the discovery-list-building process 600, according to some embodiments of this disclosure, which generally starts with creating the top-level starting point and then building the discovery list.

At step 602, the top-level starting point (that is, the root cluster) is created. Every realm has its own top-level domain (TLD), and all realm-specific systems/services fall under that TLD. Every hierarchy needs a top-level root, which is called the root cluster. Its name (for example, its domain name) is a combination of the “_cluster” label, followed by the realm domain. For example, if the realm is dedi.dev, the name of the root cluster for that realm is_cluster.dedi.dev.

The above-described bootstrap rules are used to bootstrap the discovery list. As this is a cluster (_cluster.dedi.dev), a PTR record lookup is performed. Then, the discovery list is built using a bootstrap discovery lookup process.

More specifically, at step 604, DNS queries are performed with the name of the root cluster as the input parameter and following the bootstrap rules. At step 606, the results of the DNS queries are used to build the discovery list. This may (or may not) result in multiple recursive calls based on the results of the first query. The process 600 ends (step 608) after the discovery list is built.

FIG. 16B shows the detail of steps 604 and 606 in some embodiments, using an example of building a discovery list using_cluster and _hub records until no more records are left.

At step 622, node type is obtained from the parameter “value” of the DNS query, which in this example is “_cluster” or “_hub”. At step 624, the node type is checked. If the node type is “_cluster”, PTR records are obtained for the input parameter “value” (which is the name of the root cluster, and the root cluster is a cluster node) (step 632). Each PTR record comprises the names of one or more nodes under the node represented by the input parameter “value”.

For each PTR records (steps 634 to 638), the DNS query of the PTR record (that is, “rdata”) is called with the name of the node of the PTR record used as the input parameter (denoted “rdata”) (step 636), which causes re-execution of the DNS query (steps 604 and 606) with the DNS query parameter being “rdata”. Therefore, the DNS query is recursively called until the node type of the DNS query parameter becomes “_hub”.

If the node type is “_hub”, SRV records are obtained for “value” (which is a hub node) (step 642). For each SRV records (steps 644 to 648), the SRV record is added to the discovery list (that is, “[discovery set]”) (step 646).

After the recursive calling of DNS queries completes, the discovery list (that is, “[discovery set]”) is returned (step 652).

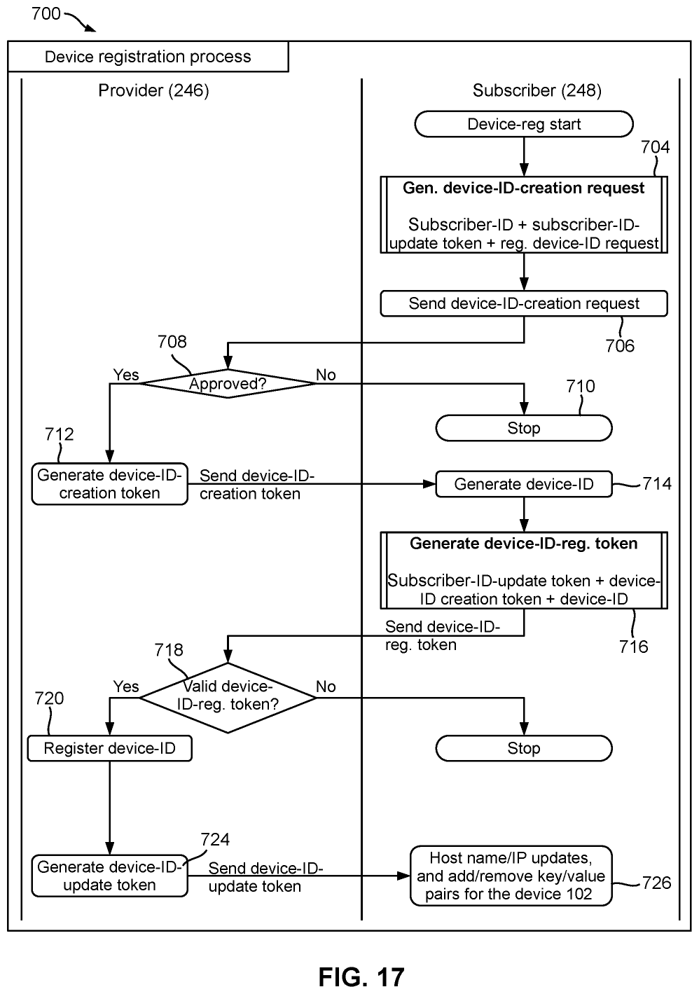

FIG. 17 is a flowchart showing the device registration process 700, according to some embodiments of this disclosure.

As shown in FIG. 17, after the device registration process 700 starts, the subscriber 248 generates a device-ID-creation request which comprises the subscriber-ID, a subscriber-ID-update token, and a registering device-ID request (step 704), and sends the device-ID-creation request to the provider 246).

If the provider 246 does not approve the request (the “No” branch of step 708), the device registration process 700 is terminated (step 710).

If the provider 246 approves the request (the “Yes” branch of step 708), the provider 246 generates a one-time device-ID-creation token (step 712) and sends it to the subscriber 248.

The subscriber 248 generates a new device-ID (step 714), and also generates a device-ID-registration token comprising the subscriber-ID-update token, the device-ID-creation token, and the newly generated device-ID (step 716). The subscriber 248 then sends the device-ID-registration token to the provider 246.

The provider 246 verifies the device-ID-registration token (step 718). If the device-ID-registration token is invalid (the “No” branch of step 718), the device registration process 700 is terminated (step 710).

If the device-ID-registration token is valid (the “Yes” branch of step 718), the provider 246 then creates a new FQDN entry for the device 102 and registers the received device-ID for the subscriber account (step 720). Then, the provider 246 generates a device-ID-update token for that device-ID (step 724) and sends it to the subscriber 248. The subscriber 248 uses the received device-ID-update token to perform hostname/IP updates in case its IP changes, and add/remove key/value pairs for the device 102 as needed (step 726). The device registration process 700 then ends.

After registration, the device 102 may register its vault 344 and nuggets 348 with the provider 246. In these embodiments, safes 346 are not registered with the provider 246. However, in other embodiments, safes 346 may be registered with the provider 246.

After the device 102 is registered, it needs to register the chosen protocols supported for query. In these embodiments, REST and DNS queries may be used for lookups.

A subscriber 248 may select at least one query type for their devices 102 to use. When a query type is selected, the subscriber 248 may also select the port the query protocol is listening on, thereby allowing the use of user-defined ports for queries.

### Element Registration and Discovery

Elements such as the device 102, vault 344, nugget 348, and the like may be registered before being used, and may be discovered for use. By default, all newly created elements are unregistered. When an element is registered, its registration state changes from unregistered to registered (see FIG. 15).

Registration servers accept and create the records that are used by the discovery servers. In some embodiments, two separate processes, that is, a registration process and a discovery process, may be used, where the registration process feeds the data to be used by the discovery process. Additionally, each process may have its own Application Programming Interface (API), meaning that there is a registration API and a discovery API. In some embodiments, discovery may not require a REST API.

Conceptually, registration and discovery are simply a triplet of {key, value [, modifier] } (where [ ] represents optional) for storing and looking up. The modifier is an optional value to allow filtering on additional criteria for the same key.

Those skilled in the art will appreciate that, to improve security and the confidentiality of IDs, IDs are never published directly. Instead, their hash is published and stored, and only these hashes are queried, which means that not only do providers 246 never see the secrets held by their subscribers 248, but the providers 246 never see or know any of the actual IDs being registered or used.

In some embodiments, the syntax (or vocabulary) of the registries process corresponds to the discovery syntax. In general, the bulk of records registered are the following:

| Key | Value |
|---|---|
| device | ip[:port] |
| vault | device |
| nugget | vault |

In some embodiments, the following registration rules are used:

### 1. Registering Device 102:

A device 102 registers its locator, which is the information, such as the device's IP:port, the device's fully qualified domain name (FQDN), hostname, or the like, needed for locating the device 102). The following uses IP:port as an example of the locator.
A device 102 can only register one IP:port record.

### 2. Registering Vault 344:

A vault 344 registers what device 102 it resides on.
a vault 344 can register multiple device records.

### 3. Registering Nugget 348:

A nugget 348 registers what vault 344 it resides in.
A nugget 348 can only register one vault record.

Some record registration types may be unregistered or removed before it can be changed, which prevents accidental overwriting of existing records.

In the following examples, MD5 hash is used for simplicity. Those skilled in the art will understand that any suitable hashes such as SHA3-256 or the like may be used.

In one example, the following elements shown in Table 3 are to be registered (see Table 2 for the meanings of prefix ng, vt, and dv), wherein element names are added for ease of reference.

TABLE 3
ELEMENTS TO BE REGISTERED

| Element | | |
|---|---|---|
| Name | Element ID | Hash of Element ID |
| Nugget1 | ng-16j2nwwxxefv2gwcjs77msxnz9z5samk597xmdgd | 4325dcac2ee3f6e2521c512a8095667b |
| Nugget2 | ng-p72ev5njtccmpgz6ddb47pcc1z70zaydatbgee5j | 2d3776facd30a428b20c8e5a1dc976c4 |
| Vault1 | vt-s1ky59k3h62venn1e70ffvqzhz0qcd771e60c31f | 325385e793acfd36695d27c50230dab9 |
| Device1 | dv-a3ydp367txv49fxkq9xkt0ajtb8rc37pcanwtfav | 7f169bbb16f476ab965a3610b24e55d8 |
| Device2 | dv-nandsarp4yj54tp177bm08ty1pfg1k0z4ajgk6e8 | b24d51ba40b607f420f1da1e04871da3 |

In this example, the two devices, Device1 and Device2 are first registered. In other words, once a device is up and running, it needs to register itself with its upstream provider (see FIG. 8).

The two devices in Table 3 may be registered as (in the format of “Hash of device ID, IP:port”):

| | |
|---|---|
| 7f169bbb16f476ab965a3610b24e55d8, | 10.0.0.1:4567 |
| b24d51ba40b607f420f1da1e04871da3, | 10.1.0.1:4567 |

These two records mean that the devices (represented by the corresponding hashes) are ready and available on the listed Ips and ports, which mean the following correspondences (shown in the format of “Device ID, IP:port”);

| | |
|---|---|
| dv-a3ydp367txv49fxkq9xkt0ajtb8rc37pcanwtfav, | 10.0.0.1:4567 |
| dv-nandsarp4yj54tp177bm08ty1pfg1k0z4ajgk6e8, | 10.1.0.1:4567 |

In this example, the vault, Vault1, resides on Device 1. When Vault1 is ready, it is registered as (in the format of “Hash of vault ID, Hash of device ID”):

| | |
|---|---|
| 325385e793acfd36695d27c50230dab9, | 7f169bbb16f476ab965a3610b24e55d8 |

This record means the following correspondence (in the format of “Vault ID, Device ID”):

| | |
|---|---|
| vt-s1ky59k3h62venn1e70ffvqzhz0qcd771e60c31f, | dv-a3ydp367txv49fxkq9xkt0ajtb8rc37pcanwtfav |

In this example, the vault on Device2 acts as a redundant and/or fail-over and/or load-balanced option for Vault1. Then, Device2 also registers a vault with the same ID of Vault1 (in the format of “Hash of vault ID, Hash of device ID”):

| | |
|---|---|
| 325385e793acfd36695d27c50230dab9, | b24d51ba40b607f420f1da1e04871da3 |

This record means the following correspondence (in the format of “Vault ID, Device ID”):

| | |
|---|---|
| vt-s1ky59k3h62venn1e70ffvqzhz0qcd771e60c31f, | dv-nandsarp4yj54tp177bm08ty1pfg1k0z4ajgk6e8 |

When a nugget is ready to be queried, it registers the following (for this example, assume both nuggets are ready at the same time) (in the format of “Hash of nugget ID, Hash of vault ID”):

| | |
|---|---|
| 4325dcac2ee3f6e2521c512a8095667b, | 325385e793acfd36695d27c50230dab9 |
| 2d3776facd30a428b20c8e5a1dc976c4, | 325385e793acfd36695d27c50230dab9 |

These records mean the following correspondences (in the format of “Nugget ID, Vault ID”):

| | |
|---|---|
| ng-16j2nwwxxefv2gwcjs77msxnz9z5samk597xmdgd | vt-s1ky59k3h62venn1e70ffvqzhz0qcd771e60c31f |
| ng-p72ev5njtccmpgz6ddb47pcc1z70zaydatbgee5j, | vt-s1ky59k3h62venn1e70ffvqzhz0qcd771e60c31f |

Thus, in these embodiments, no element IDs are registered, and rather, the registration process registers the elements' hashes, which prevent an attacker from discovering what these hashes are actually pointing to.

FIG. 18 is a schematic diagram showing the system 100 performing the discovery process. As a comparison, FIG. 19 shows a conventional system 900 wherein data is stored in a server computer 102 and the conventional system 900 does not comprise any discovery server.

As shown in FIG. 18, the system 100 comprises a plurality of storage servers or devices 102 connecting to the network or cloud 108. The system also comprises one or more discovery servers 816 connecting to the cloud 108.

A user 802 uses a client computing device 104 to use a nugget ID (denoted “nugget-id”) to query a key 806 via an app 808 and SDK/REST 810.

Before performing the query, a discovery process is performed wherein an application or a user determines where an element (such as a nugget, a vault, an application, a user, a device, or the like) resides. In these embodiments, the discovery process uses the following steps for discovery when a nugget-id is provided:
1. Convert the nugget-id to the hash of nugget ID (denoted “nugget-id-hash”).
2. Lookup nugget-id-hash to obtain the hash of vault ID (denoted “vault-id-hash”).
3. Lookup vault-id-hash to obtain a list of one or more hashes of device IDs (denoted “device-id-hashes”).
4. Lookup each device-id-hash to obtain the IP:port that the corresponding device is running on.

The discovery process starts with an entity receiving a nugget-id from a subscriber. This nugget-id contains the key/secret to the information the subscriber needs to access. This nugget-id is typically sent out-of-band (email, manually sent, or the like).

For example, a subscriber sends to a client the following nugget-id of a nugget containing the decryption key for a file:

ng-p72ev5njtccmpgz6ddb47pcc1z70zaydatbgee5j

With this information, the client may start the discovery process as follows:

### 1. Convert the Nugget-Id to Nugget-Id-Hash:

The hash of ng-p72ev5njtccmpgz6ddb47pcc1z70zaydatbgee5j is:

2d3776facd30a428b20c8e5a1dc976c4

### 2. Lookup Nugget-Id-Hash to Obtain Vault-Id-Hash:

The nugget-id-hash is sent to the discovery servers to obtain the record. Based on the information above, the obtained record is (in the format of “nugget-id-hash, vault-id-hash”):

| | |
|---|---|
| 2d3776facd30a428b20c8e5a1dc976c4, | 325385e793acfd36695d27c50230dab9 |

This record indicates the nugget-id-hash and the vault-id-hash of the vault that the nugget resides on, and means the following correspondence (in the format of “nugget-id, vault-id”):

| | |
|---|---|
| ng-p72ev5njtccmpgz6ddb47pcc1z70zaydatbgee5j, | vt-s1ky59k3h62venn1e70ffvqzhz0qcd771e60c31f |

Thus, the vault that the nugget resides on is discovered.

### 3. Lookup Vault-Id-Hash to Obtain a List of One or More Device-Id-Hashes:

The vault-id-hash is sent to the discovery servers to obtain the record. Based on the information above, two records are obtained (in the format of “vault-id-hash, device-id-hash”):

| | |
|---|---|
| 325385e793acfd36695d27c50230dab9, | 7f169bbb16f476ab965a3610b24e55d8 |
| 325385e793acfd36695d27c50230dab9, | b24d51ba40b607f420f1da1e04871da3 |

These records indicate the vault-id-hash and the device-id-hashes of the devices that the vault resides on, and mean the following correspondences (in the format of “vault-id, device-id”):

| | |
|---|---|
| vt-s1ky59k3h62venn1e70ffvqzhz0qcd771e60c31f, | dv-a3ydp367txv49fxkq9xkt0ajtb8rc37pcanwtfav |
| vt-s1ky59k3h62venn1e70ffvqzhz0qcd771e60c31f, | dv-nandsarp4yj54tp177bm08ty1pfg1k0z4ajgk6e8 |

Thus, the devices that the vault resides on are discovered.

4. Lookup Device-Id-Hash to Obtain IP:Port that Each Device is Running on

The device-id-hashes are sent to the discovery servers to obtain the record. Based on the information above, two records are obtained (in the format of “device-id-hash, IP:port”):

| | |
|---|---|
| 7f169bbb16f476ab965a3610b24e55d8, | 10.0.0.1:4567 |
| b24d51ba40b607f420f1da1e04871da3, | 10.1.0.1:4567 |

These records mean the following correspondences (in the format of “device-id, IP:port”):

| | |
|---|---|
| dv-a3ydp367txv49fxkq9xkt0ajtb8rc37pcanwtfav, | 10.0.0.1:4567 |
| dv-nandsarp4yj54tp177bm08ty1pfg1k0z4ajgk6e8, | 10.1.0.1:4567 |

Thus, the Ips and ports of the devices are discovered. Queries may be sent to the discovered IPs and ports for information access. More specifically, the nugget of nugget-ID

ng-p72ev5njtccmpgz6ddb47pcc1z70zaydatbgee5j

may be queried from one vault:

vt-s1ky59k3h62venn1e70ffvqzhz0qcd771e60c31f

This vault resides on two devices. Those two devices are 10.0.0.1 on port 4567 and 10.1.0.1 on port 4567

dv-a3ydp367txv49fxkq9xkt0ajtb8rc37pcanwtfav
dv-nandsarp4yj54tp177bm08ty1pfg1k0z4ajgk6e8

These two devices are at the IP address 10.0.0.1 on port 4567 and the IP address 10.1.0.1 on port 4567, respectively.

In some embodiments, sending nugget-id may include a registration and discovery lookup on an app-ID→nugget-ID[:modifier] record (wherein “app” refers to “application” or “application program”).

After element registration, devices 102 may send heartbeats (a periodic signal for indicating normal operation or for synchronization) at regular intervals (such as 3600 seconds (that is, 60 minutes)) to their upstream providers 246, thereby allowing the providers 246 to cycle out or otherwise devices 102 no longer responsive or devices 102 being removed without notification. For example, when a provider 246 has not received six (6) consecutive heartbeats from a device 102, the provider 246 may cycle out or otherwise exclude this device 102, along with all the information registered therewith. The cycled-out device 102 has to go through the above-described registration process again in order to come back online.

### Service Rotation:

### Service Rotation Comprises Port Rotation.

Each device 102 may support port rotation under specific deployments, wherein a range of ports of a device 102 may be defined such that the “in use” port may be rotated among the ports within the range on a predetermined basis.

In some embodiments, time-based port rotation is used when a port in a service definition is set to “0”. If port rotation is selected, both the device 102 and the application querying the device 102 must exchange information such that the device 102 sends a time-based one-time password (TOTP) port rotation seed and the seed TTL to the application. This allows both the device 102 and the application to remain in synchronization as to which port is in-use and the port's TTL before the in-use port is rotated.

As described above, a vault 344 may be replicated to a plurality of devices or storage servers 102 for redundancy, failure prevention, and/or load balancing. When a vault-id to device-id lookup returns more than one device to query, the system may try each of these devices in the order received, and, once the device is found, stop querying others of these devices. All queries are performed using non-blocking synchronous methodologies for preventing any query from delaying the response.

When a vault is on a plurality of devices 102, the devices 102 must keep their information, such as their safes, nuggets, state information, authentication tokens, logs, and/or the like, in synchronization such that each of these devices 102 may take over from another device with little or no missing information. Synchronization may be conducted in real-time or nearly real-time with a combination of message queuing and a consensus method such as the RAFT algorithm, the practical Byzantine fault tolerance algorithm, or the like.

### D-5. Encryption

Herein, the computer network system 100 may use necessary encryption methods to encrypt information or data. For example, in some embodiments, all information stored within a device 102 (such as the operation system (OS), application programs, logs, data, and/or the like) may be encrypted. In some embodiments, all communications to or from a device is encrypted, and may be multi-encrypted depending on the subscriber stack and the encryption modules used.

Various industry accepted cipher suites or encryption methods may be used to encrypt data, or used to generate keys or certificates, including post-quantum cryptography.

In some embodiments, the computer network system 100 may use any suitable authentication and authorization methods such as verifiable credentials, decentralized identifiers, hardware and software fail-safe switches (for example, multi-signature), secret recovery key pair, split nuggets (for example, using Shamir's secret sharing method), and/or the like.

### D-6. Secure Communications Over Insecure Channels

In some embodiments, the computer network system 100 may use transport layer security (TLS) certificates for securing HTTP/REST. More specifically, the HTTP protocol may be secured by a device TLS encryption certificate thereby resulting in an HTTPS session. By using the domain-validated certificates, the certificate request/renew process may be fully automated.

However, the computer network system 100 in some embodiments requires an official certificate authority (CA) which may be expensive from not only a monetary point of view but also the operational and infrastructure requirements to meet the certifications. Moreover, a CA may be compromised by supply-chain attacks. If any CA along the path is compromised, the security of the entire chain is lost.

Alternatively, the computer network system 100 may use nonprofit CA such as “Let's Encrypt” (LE) for providing TLS certificates, which may require the end-device be accessible on fixed ports such as ports 80 and 443 in order to issue the certificate.

The computer network system 100 may use the “DNS challenge” type (see https://letsencrypt.org/docs/challenge-types/#dns-01-challenge) for certificates from “Let's Encrypt”. Part of the device registration process is to have the correct DNS entries populated when asking for a TLS certificate for administration or for the REST API.

However, if port rotation is used, the requirement of fixed ports becomes infeasible and impracticable, especially if the end-device is behind a firewall.

LE also requires a specially crafted file to exist at a specific URL in the computer network system 100 if the HTTP-01 challenge type is used. Adding any other non-REST URL on a REST-only system might introduce the possibility of an exploit. Moreover, the issued certificate is only usable for the “named site”, and if the site name changes, the certificate becomes invalid. Thus, a replicated vault cannot be truly replicated as the certificates would all need to change depending on the device it is on.

LE may use DNS verification of a host. However, as the DNS verification is achieved by asking for a specific text record within the domain for which the certificate is to be issued, the above-described name-change problem still exists. Moreover, some devices may not register or use “hostnames” or DNS to register upstream.

In the unlikely event that a certificate expires, the process can be fraught with problems to get it renewed. Also in the eventual event that a root CA expires, the ripple effect on CA renewals/re-issues would be operationally overwhelming.

Moreover, the overhead of becoming a CA is complex enough for the existing CA issuers as they usually require a large number of technical expert and massive amounts of infrastructure to support them.

In some embodiments, the computer network system 100 allows IPs to be registered as devices, as an alternative to FQDN.

In some embodiments, the computer network system 100 may provide secure communications over a non-secure channel, and additionally offers the option of TLS/HTTPS REST endpoints for client computing-devices 104.

In some embodiments wherein a none-secure method (such as HTTP without TLS) is used, the communication between endpoints may still be strongly secured by encrypting the data before it is sent to the receiver using the receiver's public key, which may not be susceptible to a man-in-middle attack that may otherwise occur if a CA is compromised.

A special REST route exists for this method of security.

For example, during the negotiation of abilities, public keys are exchanged for base connections and used for encryption. The client 104 requests the public key from the server 102 for the element being worked on. The server 102 uses the public key it received from the client 104 at the negotiation phase.

The client 104 calculates the hash of the public key and uses that the REST API endpoint. The client then encrypts the data to be sent to the server 102 using the public key from the server 102, and encodes the result in base64url format. The client 104 then uses a REST endpoint to send the request to the server 102.

The server 102 parses the hash to determine which public key was used to encrypt the data and retrieves its matching private key. The server 102 then decodes the base64url data back into its encrypted form, and uses the private key to decrypt the data back into its original, plaintext form. The payload of the data is then sent back into the REST API for processing. Responses may be sent back to the client 104 using a same process.

### E. Summary

The computer network system disclosed herein provides many features such as:
Organizational hierarchy for user management;
Operational hierarchy for device management;
Use of small servers and/or micro servers and/or SoCs and/or microcontrollers and/or virtualization and/or container technology as storage servers 102;
Use of micro-services and separation/independence of roles/functions for minimizing impact of potential attacks;
Bottom-up element registration and approval process;
Service traversal process and naming (for example, the shortcuts),
   _cluster: a group of other clusters, or a group of hubs providing a service (using PTR record),
   _hub: a group of servers providing a service (using SVR record),
   Server(s): the end system that an element query is sent to, to get the location of an end device that contains a vault 344,
Top-down traversal for building of registration hierarchy/discovery list;
Discovery protocol for element query:
   /server connect
   HI↔HI (for example, server sending list of capabilities to client, client choosing best combination based on its capabilities, client sending its choice to server, server confirming the choice),
   Key exchange (for example, server sending to client its public key, client beginning encryption to server using server's public key, clients send its public key to server, and then server sending back client pubkey to confirm,
   All communications in the discovery process are fully encrypted.

Element query comprises sending keywords and parameters, or answers between server 102 and client 104, which may be implemented at the REST API level on the server 102.

Each storage server or device 102 may register the following elements to its upstream provider:
device-id-hash FQDN-of-device[:port]/(IP[:port])
vault-id-hash device-id-hash
nugget-id-hash vault-id-hash

In above examples, “-hash” may be any suitable hash (such as the SHA3-256 hash) of the corresponding ID.

In some embodiments, modified protocols may be used to bypass the vault and/or device portions of the protocol, and publish the FQDN/IP of all devices at the nugget level, for example,
nugget-id-hash FQDN-of-device[:port]/(IP[:port])

Once information has been published, one may query the published information with suitable formats, for example:
nugget nugget-id-hash (for querying the remote for vault that hosts the named nugget)
vault vault-id-hash (for querying the remote for the device(s) that host the named vault)
device device-id-hash (for querying the remote for the FQDN/IP of the named device).

More specifically, the query process may be:
1) Ask the system if it knows which vault the listed nugget-id is hosted. (in this list, “id” refers to the actual ID of the element or the hash thereof, depending on the implementation).
2) If the system does not know, it returns an “unknown” response.
3) If the system knows, it returns the vault-id hosting that.
4) Ask the system if it knows which device the listed vault is hosted.
5) If the system does not know, it returns an “unknown” response.
6) If the system does know, it returns the device-id(s) hosting that vault.
7) Ask the system if it knows the FQDN/IP for the listed device-id.
8) If the system does not know, it returns an “unknown” response.
9) If the system does know, it returns the FQDN/IP and PORT of the named device.

As the user or client progresses through the registration hierarchy, it may discover the devices that host the vaults, the vaults that host the nuggets, and the FQDN/IP (and service port) for each of those devices.

In some embodiments, the computer network system 100 also provides a hierarchy for service delivery. At the top level thereof is the realm 302 and the realm owner (that is, the service host 242). While realms 302 are generally independent to each other, realm trusts may be set up.

There may be one or more partners 244 under a real owner 242, one or more providers 246 under a partner 244, and one or more subscribers 248 under a provider 246. Providers 246 are the entities that provide the end-service and devices 102 to the service subscribers 248 thereunder. Subscribers 248 are the entities that own or lease the individual devices 102 (such as key servers), and are the key owners.

A Realm owner 242 may also be a partner 244 to the corresponding realm 302.

When a subscriber 248 wants to run their own key server 102, they must register it with a provider 246. In other words, when a new key device 102 is to be turned up, it registers itself with the upstream service provider 246. Once registered, the device 102 may populate the registry with a list of its elements that are used in the service. The service provider 246 then takes this registration information and publishes it for query initiated by client computing-devices or applications.

Queries for a key are performed in two steps: building the discovery list, followed by querying the servers 102 returned in the discovery list. The query process does not have to wait for the discovery list building process to finish. Queries may be sent asynchronously as results are returned by the building process.

Although embodiments have been described above with reference to the accompanying drawings, those of skill in the art will appreciate that variations and modifications may be made without departing from the scope thereof as defined by the appended claims.

What is claimed is:

1. A method comprising:
selectively storing one or more data pieces in at least one first device based on a group of one or more characteristics of the one or more data pieces and/or one or more characteristics of the at least one first device, the at least one first device being a physical or virtual device;
wherein the one or more characteristics of the one or more data pieces and the one or more characteristics of the at least one first device are unrelated to a storage capacity of the at least one first device.

2. The method of claim 1, wherein said selectively storing the one or more data pieces in the at least one first device comprises:
selecting one of the at least one first device;
determining that the group of the one or more characteristics of the one or more data pieces and/or the one or more characteristics of the at least one first device satisfy a group of one or more conditions; and
storing the one or more data pieces in the selected one of the at least one first device.

3. The method of claim 2, wherein the group of one or more conditions comprise:
a total number of the one or more data pieces being smaller than or equal to a predefined maximum data-piece number;
the one or more data pieces belonging to a same owner or a predefined maximum number of multiple owners;
the one or more data pieces being related to a same application program or a predefined maximum number of multiple application programs;
the one or more data pieces being encrypted using a same encryption key or a predefined maximum number of multiple encryption keys;
the one or more data pieces being encrypted using mutually different encryption keys;
the one or more data pieces being a same type;
the one or more data pieces being encrypted, and encrypted the one or more data pieces and one or more cryptographic keys stored in the in at least one first device being unrelated to the encrypted one or more data pieces;
or a combination thereof.

4. The method of claim 1 further comprising:
managing one or more users and the at least one first device using a first hierarchical structure of the one or more users, a second hierarchical structure of the at least one first device, and a mapping between the first and second hierarchical structures.

5. The method of claim 4, wherein the first hierarchical structure comprises:
a top-level node of service host,
one or more nodes of partners associated with the node of service host,
one or more nodes of providers associated with each of the one or more nodes of partners, and
one or more nodes of subscribers associated with each of the one or more nodes of providers; and
wherein the one or more users comprise the service host, the one or more partners, the one or more providers, and the one or more node of subscribers.

6. The method of claim 5, wherein said managing the one or more users and the at least one first device comprises:
managing a first user of the one or more users, the first user being classified as one of the one or more partners, one of the one or more partners, or one of the one or more subscribers; and
wherein said managing the first user comprises:
receiving a join request from a computing device,
generating a registration token,
sending the registration token to the computing device,
receiving an identifier (ID) of the first user and a join token from the computing device,
verifying the join token,
registering the ID of the first user,
generating an ID-update token, and
sending the ID-update token to the computing device.

7. The method of claim 6, wherein said managing the one or more users and the at least one first device further comprises:
updating information of the first user using the ID-update token.

8. The method of claim 5, wherein the second hierarchical structure comprises:
a top-level node of realm;
one or more nodes of perimeters associated with the node of realm;
one or more nodes of bunkers associated with each of the one or more nodes of perimeters; and
a node of the at least one first device associated with one of the one or more nodes of bunkers.

9. The method of claim 8, wherein the node of realm is mapped the node of service host, the one or more nodes of perimeters are mapped to the one or more nodes of partners, the one or more nodes of bunkers are mapped to the one or more nodes of providers, and the node of the at least one first device is mapped to one of the one or more nodes of subscribers.

10. The method of claim 1 further comprising:
creating a first safe in the at least one first device;
creating a first nugget in the first safe; and
storing one of the one or more data pieces in the first nugget;
wherein the first safe and the first nugget are data structures.

11. The method of claim 10, wherein the first nugget comprises metadata.

12. The method of claim 10, wherein said creating the first safe in the at least one first device comprises:
creating a vault in the at least one first device; and
creating the first safe in the vault;
wherein the vault is a data structure.

13. The method of claim 12, wherein each of the at least one first device only comprises one vault.

14. The method of claim 10, wherein the first nugget is of a first type; and
wherein the first type of for data storage and is accessible without through another nugget.

15. The method of claim 10, wherein the first nugget is of a second type; and
wherein the second type is for data storage and is accessible through a nugget of a third type.

16. The method of claim 15, wherein the third type is for storing a link pointing to a second-type nugget.

17. The method of claim 15 further comprising:
storing a second-type nugget or storing a third-type nugget;
wherein said storing the second-type nugget comprises:
identifying a second safe that does not have any third-type nugget, and
storing the second-type nugget in the second safe; and
wherein said storing the second-type nugget comprises:
identifying a third safe that does not have any second-type nugget, and
storing the third-type nugget in the third safe.

18. The method of claim 15 further comprising:
manipulating a second-type nugget or a third-type nugget in accordance with the following rules:
storing the second-type nugget and the third-type nugget in different safes;
disallowing storage of a link pointing to a first-type nugget in the third-type nugget;
disallowing storage of a link pointing to a second-type nugget in the third-type nugget if the second-type nugget and the third-type nugget are in a same safe;
disallowing updating of a link stored in the third-type nugget;
allowing updating of data stored in the second-type nugget via a link stored in the third-type nugget that points to the second-type nugget; or
a combination thereof.

19. The method of claim 10 further comprising:
finding the first nugget by searching the at least one first device using an ID of the first nugget; or
finding the first nugget by (i) searching the at least one first device using an ID of a query initiator to obtain a nugget list, and (ii) searching the nugget list using the ID of the first nugget.

20. The method of claim 1 further comprising:
calling a domain name system (DNS) query function with a name of a root cluster to obtain a list of addresses of one or more first discovery servers;
wherein the root cluster comprises a plurality of discovery servers including the one or more first discovery servers; and
wherein the DNS query function receives an input parameter and comprises:
determining a node type of the input parameter,
if the node type of the input parameter is a first node type, obtaining one or more DNS pointer (PTR) records for the input parameter, and for each PTR record of the one or more PTR records, calling the DNS query function with a name of a node in the PTR record as the input parameter,
if the node type of the input parameter is a second node type, obtaining one or more DNS service (SRV) records for the input parameter, and including addresses in the one or more SRV records into the list of addresses of the one or more first discovery servers.

21. The method of claim 1, wherein said managing the at least one first device comprises:
receiving a creation request from the at least one first device;
generating a device-ID-creation token;
sending the device-ID-creation token to the at least one first device;
receiving a device ID of the at least one first device and a device-ID-registration token from the at least one first device;
verifying the device-ID-registration token;
registering the device ID;
generating a device-ID-update token; and
sending the device-ID-update token to the at least one first device.

22. The method of claim 10 further comprising:
converting a nugget ID in a received query to a hash of the nugget ID;
searching the hash of the nugget ID to obtain a hash of a vault ID;
searching the hash of the vault ID to obtain a list of one or more hashes of device IDs; and
searching each hash of the one or more hashes of device IDs to obtain an IP address and port of a device corresponding to the hash.

23. A computer system comprising:
one or more storage media; and
one or more processors connected to the one or more storage media for:
selectively storing one or more data pieces in at least one first device based on a group of one or more characteristics of the one or more data pieces and/or one or more characteristics of the at least one first device, the at least one first device being a physical or virtual device;
wherein the one or more characteristics of the one or more data pieces and the one or more characteristics of the at least one first device are unrelated to a storage capacity of the at least one first device.

24. The computer system of claim 23, wherein said selectively storing the one or more data pieces in the at least one first device comprises:
selecting one of the at least one first device;
determining that the group of the one or more characteristics of the one or more data pieces and/or the one or more characteristics of the at least one first device satisfy a group of one or more conditions; and
storing the one or more data pieces in the selected one of the at least one first device.

25. The computer system of claim 24, wherein the group of one or more conditions comprise:
a total number of the one or more data pieces being smaller than or equal to a predefined maximum data-piece number;
the one or more data pieces belonging to a same owner or a predefined maximum number of multiple owners;
the one or more data pieces being related to a same application program or a predefined maximum number of multiple application programs;
the one or more data pieces being encrypted using a same encryption key or a predefined maximum number of multiple encryption keys;
the one or more data pieces being encrypted using mutually different encryption keys;
the one or more data pieces being a same type;
the one or more data pieces being encrypted, and encrypted the one or more data pieces and one or more cryptographic keys stored in the in at least one first device being unrelated to the encrypted one or more data pieces;
or a combination thereof.

26. The computer system of claim 23, wherein the at least one first device is further configured for:
managing one or more users and the at least one first device using a first hierarchical structure of the one or more users, a second hierarchical structure of the at least one first device, and a mapping between the first and second hierarchical structures.

27. The computer system of claim 26, wherein the first hierarchical structure comprises:
a top-level node of service host,
one or more nodes of partners associated with the node of service host,
one or more nodes of providers associated with each of the one or more nodes of partners, and
one or more nodes of subscribers associated with each of the one or more nodes of providers; and
wherein the one or more users comprise the service host, the one or more partners, the one or more providers, and the one or more node of subscribers.

28. The computer system of claim 27, wherein said managing the one or more users and the at least one first device comprises:
managing a first user of the one or more users, the first user being classified as one of the one or more partners, one of the one or more partners, or one of the one or more subscribers; and
wherein said managing the first user comprises:
receiving a join request from a computing device,
generating a registration token,
sending the registration token to the computing device,
receiving an identifier (ID) of the first user and a join token from the computing device,
verifying the join token,
registering the ID of the first user,
generating an ID-update token, and
sending the ID-update token to the computing device.

29. The computer system of claim 28, wherein said managing the one or more users and the at least one first device further comprises:
updating information of the first user using the ID-update token.

30. The computer system of claim 27, wherein the second hierarchical structure comprises:
a top-level node of realm;
one or more nodes of perimeters associated with the node of realm;
one or more nodes of bunkers associated with each of the one or more nodes of perimeters; and
a node of the at least one first device associated with one of the one or more nodes of bunkers.

31. The computer system of claim 30, wherein the node of realm is mapped the node of service host, the one or more nodes of perimeters are mapped to the one or more nodes of partners, the one or more nodes of bunkers are mapped to the one or more nodes of providers, and the node of the at least one first device is mapped to one of the one or more nodes of subscribers.

32. The computer system of claim 23, wherein the at least one first device is further configured for:
creating a first safe in the at least one first device;
creating a first nugget in the first safe; and
storing one of the one or more data pieces in the first nugget;
wherein the first safe and the first nugget are data structures.

33. The computer system of 32, wherein the first nugget comprises metadata.

34. The computer system of claim 32, wherein said creating the first safe in the at least one first device comprises:
creating a vault in the at least one first device; and
creating the first safe in the vault;
wherein the vault is a data structure.

35. The computer system of claim 34, wherein each of the at least one first device only comprises one vault.

36. The computer system of claim 32, wherein the first nugget is of a first type; and
wherein the first type of for data storage and is accessible without through another nugget.

37. The computer system of claim 32, wherein the first nugget is of a second type; and
wherein the second type is for data storage and is accessible through a nugget of a third type.

38. The computer system of claim 37, wherein the third type is for storing a link pointing to a second-type nugget.

39. The computer system of claim 37, wherein the at least one first device is further configured for:
storing a second-type nugget or storing a third-type nugget;
wherein said storing the second-type nugget comprises:
identifying a second safe that does not have any third-type nugget, and
storing the second-type nugget in the second safe; and
wherein said storing the second-type nugget comprises:
identifying a third safe that does not have any second-type nugget, and
storing the third-type nugget in the third safe.

40. The computer system of claim 37, wherein the at least one first device is further configured for:
manipulating a second-type nugget or a third-type nugget in accordance with the following rules:
storing the second-type nugget and the third-type nugget in different safes;
disallowing storage of a link pointing to a first-type nugget in the third-type nugget;
disallowing storage of a link pointing to a second-type nugget in the third-type nugget if the second-type nugget and the third-type nugget are in a same safe;
disallowing updating of a link stored in the third-type nugget;
allowing updating of data stored in the second-type nugget via a link stored in the third-type nugget that points to the second-type nugget; or
a combination thereof.

41. The computer system of claim 32, wherein the at least one first device is further configured for:
finding the first nugget by searching the at least one first device using an ID of the first nugget; or
finding the first nugget by (i) searching the at least one first device using an ID of a query initiator to obtain a nugget list, and (ii) searching the nugget list using the ID of the first nugget.

42. The computer system of claim 23, wherein the at least one first device is further configured for:
calling a DNS query function with a name of a root cluster to obtain a list of addresses of one or more first discovery servers;
wherein the root cluster comprises a plurality of discovery servers including the one or more first discovery servers; and
wherein the DNS query function receives an input parameter and comprises:
determining a node type of the input parameter,
if the node type of the input parameter is a first node type, obtaining one or more DNS pointer (PTR) records for the input parameter, and for each PTR record of the one or more PTR records, calling the DNS query function with a name of a node in the PTR record as the input parameter,
if the node type of the input parameter is a second node type, obtaining one or more DNS service (SRV) records for the input parameter, and including addresses in the one or more SRV records into the list of addresses of the one or more first discovery servers.

43. The computer system of claim 23, wherein said managing the at least one first device comprises:
receiving a creation request from the at least one first device;
generating a device-ID-creation token;
sending the device-ID-creation token to the at least one first device;
receiving a device ID of the at least one first device and a device-ID-registration token from the at least one first device;
verifying the device-ID-registration token;
registering the device ID;
generating a device-ID-update token; and
sending the device-ID-update token to the at least one first device.

44. The computer system of claim 32, wherein the at least one first device is further configured for:
converting a nugget ID in a received query to a hash of the nugget ID;
searching the hash of the nugget ID to obtain a hash of a vault ID;
searching the hash of the vault ID to obtain a list of one or more hashes of device IDs; and
searching each hash of the one or more hashes of device IDs to obtain an IP address and port of a device corresponding to the hash.

45. One or more non-transitory computer-readable storage media comprising computer-executable instructions, wherein the instructions, when executed, cause one or more processors to perform actions comprising:
selectively storing one or more data pieces in at least one first device based on a group of one or more characteristics of the one or more data pieces and/or one or more characteristics of the at least one first device, the at least one first device being a physical or virtual device;
wherein the one or more characteristics of the one or more data pieces and the one or more characteristics of the at least one first device are unrelated to a storage capacity of the at least one first device.

46. The one or more non-transitory computer-readable storage media of claim 45, wherein said selectively storing the one or more data pieces in the at least one first device comprises:
selecting one of the at least one first device;
determining that the group of the one or more characteristics of the one or more data pieces and/or the one or more characteristics of the at least one first device satisfy a group of one or more conditions; and
storing the one or more data pieces in the selected one of the at least one first device.

47. The one or more non-transitory computer-readable storage media of claim 46, wherein the group of one or more conditions comprise:
a total number of the one or more data pieces being smaller than or equal to a predefined maximum data-piece number;
the one or more data pieces belonging to a same owner or a predefined maximum number of multiple owners;
the one or more data pieces being related to a same application program or a predefined maximum number of multiple application programs;
the one or more data pieces being encrypted using a same encryption key or a predefined maximum number of multiple encryption keys;
the one or more data pieces being encrypted using mutually different encryption keys;
the one or more data pieces being a same type;
the one or more data pieces being encrypted, and encrypted the one or more data pieces and one or more cryptographic keys stored in the in at least one first device being unrelated to the encrypted one or more data pieces;
or a combination thereof.

48. The one or more non-transitory computer-readable storage media of claim 45, wherein the instructions, when executed, cause the one or more processors to perform further actions comprising:
managing one or more users and the at least one first device using a first hierarchical structure of the one or more users, a second hierarchical structure of the at least one first device, and a mapping between the first and second hierarchical structures.

49. The one or more non-transitory computer-readable storage media of claim 47, wherein the first hierarchical structure comprises:
a top-level node of service host,
one or more nodes of partners associated with the node of service host,
one or more nodes of providers associated with each of the one or more nodes of partners, and
one or more nodes of subscribers associated with each of the one or more nodes of providers; and
wherein the one or more users comprise the service host, the one or more partners, the one or more providers, and the one or more node of subscribers.

50. The one or more non-transitory computer-readable storage media of claim 49, wherein said managing the one or more users and the at least one first device comprises:
managing a first user of the one or more users, the first user being classified as one of the one or more partners, one of the one or more partners, or one of the one or more subscribers; and
wherein said managing the first user comprises:
receiving a join request from a computing device,
generating a registration token,
sending the registration token to the computing device,
receiving an identifier (ID) of the first user and a join token from the computing device,
verifying the join token,
registering the ID of the first user,
generating an ID-update token, and
sending the ID-update token to the computing device.

51. The one or more non-transitory computer-readable storage media of claim 50, wherein said managing the one or more users and the at least one first device further comprises:
updating information of the first user using the ID-update token.

52. The one or more non-transitory computer-readable storage media of claim 49, wherein the second hierarchical structure comprises:
a top-level node of realm;
one or more nodes of perimeters associated with the node of realm;
one or more nodes of bunkers associated with each of the one or more nodes of perimeters; and
a node of the at least one first device associated with one of the one or more nodes of bunkers.

53. The one or more non-transitory computer-readable storage media of claim 52, wherein the node of realm is mapped the node of service host, the one or more nodes of perimeters are mapped to the one or more nodes of partners, the one or more nodes of bunkers are mapped to the one or more nodes of providers, and the node of the at least one first device is mapped to one of the one or more nodes of subscribers.

54. The one or more non-transitory computer-readable storage media of claim 45, wherein the instructions, when executed, cause the one or more processors to perform further actions comprising:
creating a first safe in the at least one first device;
creating a first nugget in the first safe; and
storing one of the one or more data pieces in the first nugget;
wherein the first safe and the first nugget are data structures.

55. The one or more non-transitory computer-readable storage media of claim 54, wherein the first nugget comprises metadata.

56. The one or more non-transitory computer-readable storage media of claim 54, wherein said creating the first safe in the at least one first device comprises:
creating a vault in the at least one first device; and
creating the first safe in the vault;
wherein the vault is a data structure.

57. The one or more non-transitory computer-readable storage media of claim 56, wherein each of the at least one first device only comprises one vault.

58. The one or more non-transitory computer-readable storage media of claim 54, wherein the first nugget is of a first type; and
wherein the first type of for data storage and is accessible without through another nugget.

59. The one or more non-transitory computer-readable storage media of claim 54, wherein the first nugget is of a second type; and
wherein the second type is for data storage and is accessible through a nugget of a third type.

60. The one or more non-transitory computer-readable storage media of claim 59, wherein the third type is for storing a link pointing to a second-type nugget.

61. The one or more non-transitory computer-readable storage media of claim 59, wherein the instructions, when executed, cause the one or more processors to perform actions comprising:
storing a second-type nugget or storing a third-type nugget;
wherein said storing the second-type nugget comprises:
identifying a second safe that does not have any third-type nugget, and
storing the second-type nugget in the second safe; and
wherein said storing the second-type nugget comprises:
identifying a third safe that does not have any second-type nugget, and
storing the third-type nugget in the third safe.

62. The one or more non-transitory computer-readable storage media of claim 59, wherein the instructions, when executed, cause the one or more processors to perform actions comprising:
manipulating a second-type nugget or a third-type nugget in accordance with the following rules:
storing the second-type nugget and the third-type nugget in different safes;
disallowing storage of a link pointing to a first-type nugget in the third-type nugget;
disallowing storage of a link pointing to a second-type nugget in the third-type nugget if the second-type nugget and the third-type nugget are in a same safe;
disallowing updating of a link stored in the third-type nugget;
allowing updating of data stored in the second-type nugget via a link stored in the third-type nugget that points to the second-type nugget; or
a combination thereof.

63. The one or more non-transitory computer-readable storage media of claim 54, wherein the instructions, when executed, cause the one or more processors to perform actions comprising:
finding the first nugget by searching the at least one first device using an ID of the first nugget; or
finding the first nugget by (i) searching the at least one first device using an ID of a query initiator to obtain a nugget list, and (ii) searching the nugget list using the ID of the first nugget.

64. The one or more non-transitory computer-readable storage media of claim 45, wherein the instructions, when executed, cause the one or more processors to perform further actions comprising:
calling a DNS query function with a name of a root cluster to obtain a list of addresses of one or more first discovery servers;
wherein the root cluster comprises a plurality of discovery servers including the one or more first discovery servers; and
wherein the DNS query function receives an input parameter and comprises:
determining a node type of the input parameter,
if the node type of the input parameter is a first node type, obtaining one or more DNS pointer (PTR) records for the input parameter, and for each PTR record of the one or more PTR records, calling the DNS query function with a name of a node in the PTR record as the input parameter,
if the node type of the input parameter is a second node type, obtaining one or more DNS service (SRV) records for the input parameter, and including addresses in the one or more SRV records into the list of addresses of the one or more first discovery servers.

65. The one or more non-transitory computer-readable storage media of claim 45, wherein said managing the at least one first device comprises:
receiving a creation request from the at least one first device;
generating a device-ID-creation token;
sending the device-ID-creation token to the at least one first device;
receiving a device ID of the at least one first device and a device-ID-registration token from the at least one first device;
verifying the device-ID-registration token;
registering the device ID;
generating a device-ID-update token; and
sending the device-ID-update token to the at least one first device.

66. The one or more non-transitory computer-readable storage media of claim 54, wherein the instructions, when executed, cause the one or more processors to perform further actions comprising:
converting a nugget ID in a received query to a hash of the nugget ID;
searching the hash of the nugget ID to obtain a hash of a vault ID;
searching the hash of the vault ID to obtain a list of one or more hashes of device IDs; and
searching each hash of the one or more hashes of device IDs to obtain an IP address and port of a device corresponding to the hash.
